(19) United States
(12) Patent Application Publication
(10) Pub. No.: US 2022/0179254 A1
(43) Pub. Date: Jun. 9, 2022

(54) DISPLAY APPARATUS

(71) Applicant: Mitsubishi Electric Corporation, Tokyo (JP)

(72) Inventors: Naoko IWASAKI, Tokyo (JP); Tae ORITA, Tokyo (JP); Takeshi ONO, Tokyo (JP); Mikio ARAKI, Tokyo (JP); Mitsuru SAKAI, Tokyo (JP)

(73) Assignee: Mitsubishi Electric Corporation, Tokyo (JP)

(21) Appl. No.: 17/604,756

(22) PCT Filed: Apr. 22, 2020
(86) PCT No.: PCT/JP2020/017285

§ 371 Date: Oct. 19, 2021

(30) Foreign Application Priority Data
May 29, 2019 (JP) 2019-100069

(51) Int. Cl. G02F 1/1333; G06F 3/041

(52) U.S. Cl. CPC G02F 1/13338; G06F 3/0414; G02F 1/133305; G06F 3/0412

(57) ABSTRACT

The vibrating element generates vibration in the touch panel. In the display apparatus, there exist three directions including an x-axis direction and a y-axis direction along the display surface and a z-axis direction orthogonal to the display surface. The plurality of supports are configured such that touch panel does not move in the x-axis direction and the z-axis direction being two directions included in the three directions. Of the three directions, the direction other than the two directions coincides with a vibration direction being a direction of vibration generated by the vibrating element. The touch panel is configured so that the touch panel is configured to move in the vibration direction.

### TECHNICAL FIELD

The present disclosure relates to a display apparatus including a touch panel.

### BACKGROUND ART

In recent years, a display apparatus on which a touch panel is mounted has been widely used in portable information apparatuses, consumer apparatuses, industrial apparatuses, in-vehicle apparatuses, and the like. The portable information apparatus is, for example, a smartphone, a tablet PC, or the like. The consumer apparatus is a home appliance or the like. Examples of the industrial apparatus include an automatic teller machine (ATM), an automatic ticket machine, a vending machine, and a factory automation (FA) apparatus.

When the operator touches the surface of the touch panel, the touch panel detects a position touched by the operator on the surface. The operator is, for example, a touch pen, a human finger, or the like. In addition, the touch panel outputs information on the position to the outside in response to detection of the position.

A touch panel has attracted attention as one piece of excellent user interface (UI) means. Methods of the touch panel include various methods such as a resistive film method, a capacitive method, and an optical method depending on a method of detecting a touched position.

On the other hand, the touch panel has no unevenness of the mechanical switch. Therefore, a touch on the touch panel is uniform, and the shape of the surface of the touch panel is not deformed by the operation. Therefore, unlike the mechanical switch, the entire process of the switch operation on the touch panel needs to be performed visually. In other words, it is difficult to perform the blind touch on the touch panel.

Thus, for example, when a function of feeding back the position of the switch, the reception of the operation of the switch, the completion of the operation, and the like using tactile sensation is added to the touch panel, blind operation can be performed. In this case, the touch panel can function also as a universal design.

For example, in recent years, mobile phones, smartphones, and the like are mounted with a tactile feedback function using vibration. Thus, a tactile feedback function using vibration in conjunction with a user's operation is rapidly becoming familiar. Therefore, the demand for more advanced tactile feedback functions is also expected to increase.

The method of generating the tactile sensation is classified into three methods such as a vibration method, an ultrasonic method, and an electric method. The vibration method is easily applied to a projected capacitive touch panel (PCAP) described below. Therefore, the vibration method can generate clear mechanical vibration and is at low cost.

The display apparatus mounted with a tactile touch panel of the vibration method includes a touch panel, a display panel, a protective plate, a vibrating element, and a housing. The touch panel detects a position at which an operator such as a touch pen or a human finger touches on the input operation surface. The display panel is provided on the back surface side of the touch panel. The protective plate covers an upper surface of the touch panel. The vibrating element vibrates the touch panel. The housing accommodates the touch panel and the display panel.

When the display apparatus mounted with the touch panel is a liquid crystal display apparatus, the weight of the entire liquid crystal module mounted with the backlight is large. In this case, it is difficult to sufficiently vibrate the touch panel due to the vibrating element.

In addition, in a situation where only the touch panel is separated from the liquid crystal display apparatus including the display panel, the vibration is easily generated in the configuration in which the touch panel is vibrated. However, in this configuration, an air layer exists between the touch panel and the display panel, and interface reflection occurs. Therefore, in this configuration, there is a problem that the display quality is deteriorated.

Thus, it is required to efficiently vibrate the touch panel of the liquid crystal display apparatus with a small force. Therefore, a structure has been developed in which only a backlight that occupies a large weight in a liquid crystal display apparatus is separated from the liquid crystal display apparatus, and a display panel and a touch panel are integrated to be vibrated.

For example, Patent Document 1 discloses a configuration of vibrating a touch panel (hereinafter, also referred to as “related configuration A”). In the related configuration A, a protective plate of the touch panel is provided at a distance from the backlight apparatus. In addition, an elastic support member is provided between the backlight apparatus and the protective plate.

In the related configuration A, the elastic support member disposed between the backlight and the protective plate is configured to expand and contract in an oblique direction with respect to the thickness direction of the protective plate. The elastic support member is, for example, a stepwise leaf spring. With this structure, in the related configuration A, various vibrations can be generated without increasing the number of vibrating elements.

### PRIOR ART DOCUMENTS

### Patent Documents

Patent Document 1: Japanese Patent Application Laid-Open No. 2018-124792

### SUMMARY

### Problem to be Solved by the Invention

It should be noted that in the related configuration A, the vibration generated in the touch panel by the vibrating element propagates in various directions, and the energy of the vibration is dispersed. Therefore, the energy of the vibration is reduced. Therefore, there is a problem that the vibration of the touch panel is reduced. Thus, suppressing reduction in the energy of vibration to be generated in the touch panel by the vibrating element is required.

The present disclosure has been made to solve such a problem, and has an object to provide a display apparatus capable of suppressing reduction in the energy of vibration to be generated in a touch panel by a vibrating element.

### Means to Solve the Problem

In order to achieve the above object, a display apparatus according to one aspect of the present disclosure includes: a display panel having a display surface being a surface for displaying an image; a touch panel bonded to the display surface of the display panel; a vibrating element configured to generate vibration in the touch panel; a backlight disposed at a position away from the display panel; and a housing configured to accommodate the touch panel and the backlight. In the display apparatus, there exist three directions including a first direction and a second direction along the display surface and a third direction orthogonal to the display surface. The first direction and the second direction are orthogonal to each other. The display apparatus further includes a plurality of supports configured so that the touch panel does not move in two directions included in the three directions. A direction other than the two directions among the three directions coincides with a vibration direction being a direction of vibration generated by the vibrating element. The touch panel is configured so that the touch panel is configured to move in the vibration direction.

### Effects of the Invention

According to the present disclosure, a vibrating element generates vibration in a touch panel. In the display apparatus, there exist three directions including a first direction and a second direction along the display surface and a third direction orthogonal to the display surface. The plurality of supports are configured such that the touch panel does not move in two directions included in the three directions. A direction other than the two directions among the three directions coincides with a vibration direction being a direction of vibration generated by the vibrating element. The touch panel is configured so that the touch panel is configured to move in the vibration direction.

Thus, the propagation in the above two directions of the vibration generated in the touch panel by the vibrating element is suppressed. Therefore, it is possible to suppress the reduction in the energy of vibration generated in the touch panel by the vibrating element.

The objects, features, aspects, and advantages of the present disclosure will become more apparent from the following detailed description and the accompanying drawings.

### BRIEF DESCRIPTION OF DRAWINGS

FIG. 1 is a plan view of the display apparatus according to a first embodiment.

FIG. 2 is a cross-sectional view of the display apparatus taken along line A1-A2 in FIG. 1.

FIG. 3 is a diagram showing a configuration of the display panel and the backlight of the first embodiment.

FIG. 4 is a diagram showing a detailed configuration of the touch panel according to the first embodiment.

FIG. 5 is a cross-sectional view showing a configuration of the support according to the first embodiment.

FIG. 6 is a cross-sectional view of the display apparatus taken along line B1-B2 in FIG. 1.

FIG. 7 is a cross-sectional view of the display apparatus in an erected state according to the first embodiment.

FIG. 8 is a plan view of a display apparatus having the configuration of the first modification.

FIG. 9 is a cross-sectional view of the display apparatus taken along line A1-A2 in FIG. 8.

FIG. 10 is a cross-sectional view of the display apparatus having the configuration of the second modification taken along line A1a-A2 in FIG. 8.

FIG. 11 is a cross-sectional view of the display apparatus having the configuration of the third modification taken along line A1a-A2 in FIG. 8.

FIG. 12 is a cross-sectional view of the display apparatus having the configuration of the fourth modification taken along line A1a-A2 in FIG. 8.

FIG. 13 is a cross-sectional view of the display apparatus having the configuration of the fifth modification taken along line A1a-A2 in FIG. 8.

FIG. 14 is a plan view of a display apparatus having the configuration of the sixth modification.

FIG. 15 is a cross-sectional view of the display apparatus having the configuration of the sixth modification taken along line B1-B2 in FIG. 14.

FIG. 16 is a cross-sectional view showing the configuration of a support according to the sixth modification.

FIG. 17 is a cross-sectional view of a display apparatus having the configuration of the seventh modification.

FIG. 18 is a cross-sectional view of the display apparatus having the modified configuration A according to the eighth modification.

FIG. 19 is a cross-sectional view of the display apparatus having the modified configuration A according to the eighth modification.

FIG. 20 is a cross-sectional view of the display apparatus having the modified configuration A according to the eighth modification.

FIG. 21 is a cross-sectional view of the display apparatus having the modified configuration B according to the eighth modification.

FIG. 22 is a cross-sectional view of the display apparatus having the modified configuration B according to the eighth modification.

FIG. 23 is a cross-sectional view of the display apparatus having the modified configuration B according to the eighth modification.

FIG. 24 is a cross-sectional view of the display apparatus having the modified configuration C according to the eighth modification.

FIG. 25 is a cross-sectional view of the display apparatus having the modified configuration C according to the eighth modification.

FIG. 26 is a cross-sectional view of the display apparatus having the modified configuration C according to the eighth modification.

FIG. 27 is a plan view of a display apparatus as a comparative example.

FIG. 28 is a cross-sectional view of the display apparatus taken along line C1-C2 in FIG. 27.

### DESCRIPTION OF EMBODIMENTS

Hereinafter, embodiments will be described with reference to the drawings. In the following drawings, the same components are denoted by the same reference numerals. The names and functions of respective components denoted by the same reference numerals are the same. Therefore, a detailed description of a part of each component denoted by the same reference numeral may be omitted.

It should be noted that the dimensions, materials, and shapes of components exemplified in the preferred embodiment, relative arrangements of such components, and the like may be appropriately changed according to the configuration, various conditions, and the like of the device. In addition, the dimensions of each component in each drawing may differ from the actual dimensions.

### First Embodiment

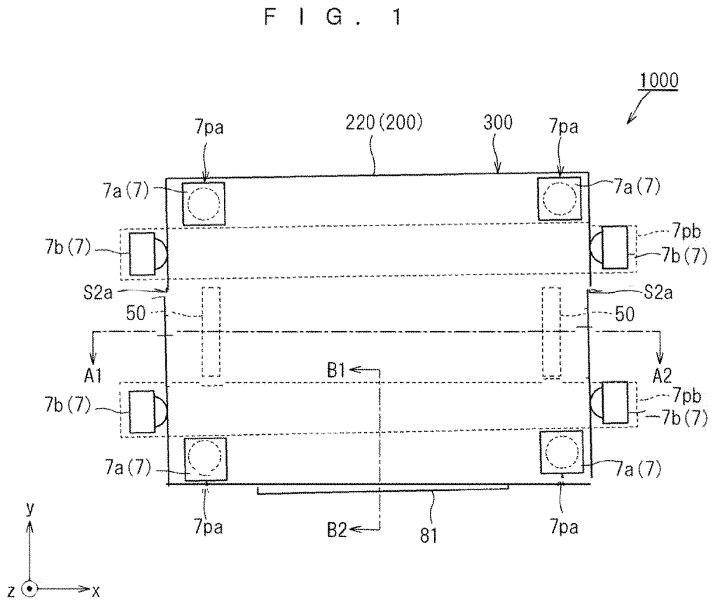

FIG. 1 is a plan view of a display apparatus 1000 according to a first embodiment. It should be noted that in FIG. 1, a housing 40 described below is not shown for easy understanding of the configuration. The display apparatus 1000 is, for example, a liquid crystal display apparatus. It should be noted that the display apparatus 1000 is not limited to a liquid crystal display apparatus.

In FIG. 1, an x-direction, a y-direction, and a z-direction are orthogonal to one another. The x-, y-, and z-directions shown in the following drawings are also orthogonal to one another. Hereinafter, a direction including the x-direction and a direction opposite to the x-direction (−x-direction) is also referred to as “x-axis direction”. In addition, hereinafter, a direction including the y direction and a direction opposite to the y direction (−y direction) is also referred to as “y-axis direction”. In addition, hereinafter, a direction including the z-direction and a direction opposite to the z-direction (−z direction) is also referred to as “z-axis direction”.

In addition, hereinafter, a plane including the x-axis direction and the y-axis direction is also referred to as “xy plane”. In addition, hereinafter, a plane including the x-axis direction and the z-axis direction is also referred to as “xz plane”. In addition, hereinafter, a plane including the y-axis direction and the z-axis direction is also referred to as “yz plane”.

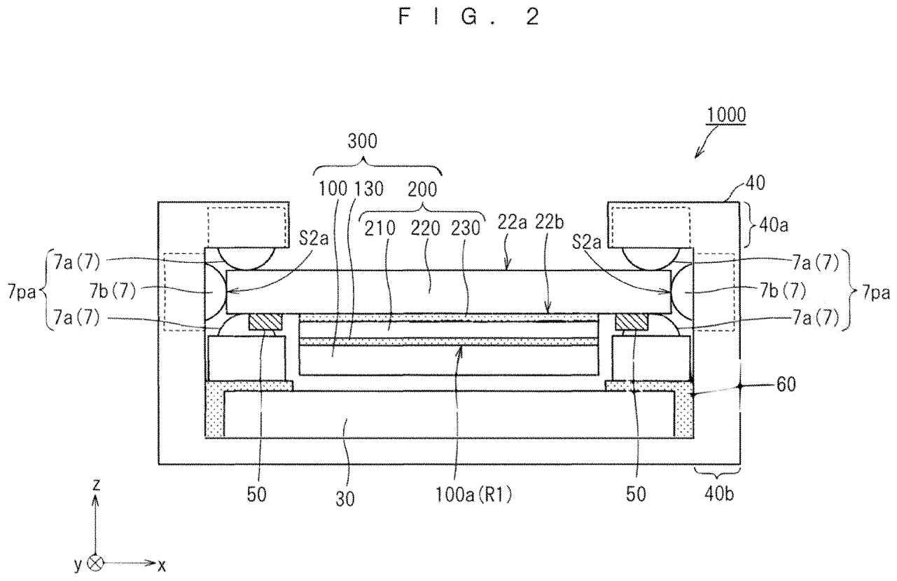

FIG. 2 is a cross-sectional view of the display apparatus 1000 taken along line A1-A2 in FIG. 1. It should be noted that, in FIG. 2, in order to make the configuration easy to understand, components (for example, supports 7a and 7b described below) that do not exist at the position of the line A1-A2 in FIG. 1 are also shown.

Referring to FIGS. 1 and 2, the display apparatus 1000 includes a display panel 100, a touch panel 200, a backlight 30, a housing 40, and a vibrating element 50. The housing 40 accommodates the display panel 100, the touch panel 200, and the backlight 30.

The display panel 100 is, for example, a liquid crystal display panel. It should be noted that the display panel 100 is not limited to the liquid crystal display panel.

Hereinafter, the image displayed by the display apparatus 1000 is also referred to as a “display image”. In addition, hereinafter, in the display apparatus 1000, a side on which the user visually recognizes the display image is also referred to as a “visually recognizing side” or a “front surface side”. The visually recognizing side (front surface side) of the display apparatus 1000 is, for example, a side on which a surface on which a display image is displayed is provided in the display apparatus 1000. Hereinafter, in the display apparatus 1000, the side opposite to the visually recognizing side is also referred to as a “back surface side”. In addition, hereinafter, in the components included in the display apparatus 1000, a surface on which a display image is displayed is also referred to as a “visually recognizing side surface” or a “user side surface”.

The visually recognizing side surface of the display apparatus 1000 is referred to as a front surface of the display apparatus 1000. In addition, the visually recognizing side surface of display panel 100 is referred to as a front surface of the display panel 100. In addition, in the display panel 100, a surface opposite to the front surface is referred to as a back surface. In addition, also in another constituent member, the visually recognizing side surface is referred to as a front surface of the other constituent member. In addition, a surface of the back surface side of another constituent member is referred to as a back surface of the other constituent member.

The display panel 100 includes a display surface 100a. The display surface 100a is a surface for displaying an image. The display surface 100a is a visually recognizing side surface. In addition, the display surface 100a includes a display region R1. The display region R1 is a region in which an image is displayed. It should be noted that in the present embodiment, the entire display surface 100a is the display region R1.

The touch panel 200 is a tactile touch panel of a vibration method. The touch panel 200 is bonded to the display surface 100a of the display panel 100 via an adhesive material 130. Therefore, the touch panel 200 and the display panel 100 are integrated. Hereinafter, a component including the touch panel 200, the adhesive material 130, and the display panel 100 is also referred to as a “movable unit 300”. The movable unit 300 is a component in which the touch panel 200 and the display panel 100 are integrated.

The touch panel 200 includes a touch sensor substrate 210 and a protective plate 220. The protective plate 220 is a transparent plate. The shape of the protective plate 220 is a rectangular parallelepiped. In addition, the shape of the protective plate 220 in a plan view (xy plane) is rectangular. The protective plate 220 is made of glass or acrylic resin. The protective plate 220 is bonded to the touch sensor substrate 210 via an adhesive material 230. Therefore, the protective plate 220 and the touch sensor substrate 210 are integrated.

The protective plate 220 has a front surface 22a and a back surface 22b. The front surface 22a is a visually recognizing side surface. The back surface 22b is a surface that covers the display surface 100a of the display panel 100. It should be noted that the touch sensor substrate 210 is bonded to the back surface 22b of the protective plate 220 via the adhesive material 230. In addition, the protective plate 220 has four side surfaces including two side surfaces S2a. The two side surfaces S2a intersect with the x-axis direction.

The vibrating element 50 has a function of generating vibration. The vibrating element 50 is provided on the back surface 22b of the protective plate 220. Therefore, the vibrating element 50 transmits vibration to the touch panel 200. That is, the vibrating element 50 generates vibration in the touch panel 200.

Hereinafter, the direction of vibration generated by the vibrating element 50 is also referred to as a “vibration direction”. In the present embodiment, the vibration direction is the y-axis direction.

The backlight 30 is disposed at a position away from the display panel 100. The rim portion of the backlight 30 is surrounded by the frame 60. That is, the frame 60 covers the rim portion of the backlight 30. The frame 60 is made of resin.

The end portion of the protective plate 220 is held by the support pair 7pa. The support pair 7pa includes two supports 7a. That is, the end portion of the protective plate 220 is sandwiched between the two supports 7a included in the support pair 7pa.

One support 7a of the two supports 7a is in contact with the front surface 22a of the protective plate 220. The other support 7a of the two supports 7a is provided on the frame 60. The other support 7a is in contact with the back surface 22b of the protective plate 220. That is, the other support 7a supports the weight of the movable unit 300 including the touch panel 200 and the display panel 100.

In addition, the two side surfaces S2a of the protective plate 220 are held by the support pair 7pb. The support pair 7pb includes two supports 7b. That is, the two side surfaces S2a of the protective plate 220 are sandwiched between the two supports 7b included in the support pair 7pb. One of the two supports 7b in the support pair 7pa is in contact with one of the two side surfaces S2a. The other of the two supports 7b in the support pair 7pa is in contact with the other of the two side surfaces S2a.

Each of the two supports 7b is attached to a side surface portion 40b described below in the housing 40. Hereinafter, each of the support 7a and the support 7b is also referred to as “support 7”.

(Display Panel)

Next, the display panel 100 will be described in detail. As described above, the display panel 100 includes the display surface 100a. The display panel 100 has a function of displaying an image on the display surface 100a according to an image signal input from the outside. The image is a moving image or a still image.

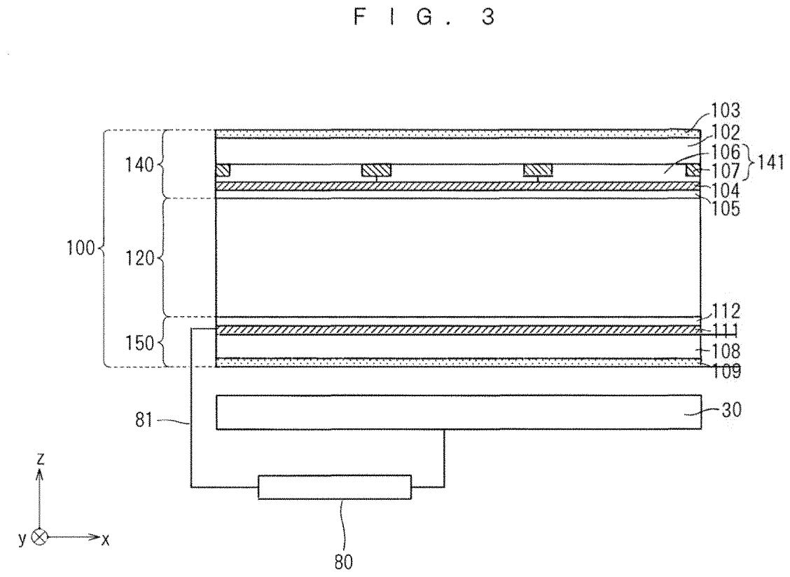

FIG. 3 is a diagram showing a configuration of the display panel 100 and the backlight 30 of the first embodiment. Referring to FIG. 3, the display panel 100 has a structure in which a liquid crystal 120 is sealed between the color filter substrate 140 and the array substrate 150. It should be noted that hereinafter, the array substrate 150 is also referred to as a “thin film transistor (TFT) substrate”.

The color filter substrate 140 includes a glass substrate 102. A color filter 141 is arranged on the back surface of the glass substrate 102. A counter electrode 104 is formed on the back surface of the color filter 141. An alignment film 105 is formed on the back surface of the counter electrode 104. In addition, a polarizing plate 103 is arranged on the front surface of the glass substrate 102. The polarizing plate 103 is attached to the glass substrate 102 via an adhesive (not shown).

The color filter 141 includes a color material 106 and a black matrix 107. The color material 106 is a member that transmits light in a wavelength region corresponding to red (R), green (G), blue (B), or the like. The black matrix 107 is a member that blocks light. The black matrix 107 is arranged between adjacent RGB pixels.

The counter electrode 104 is an electrode for applying a voltage to the liquid crystal 120. The counter electrode 104 is made of, for example, a transparent conductive film such as indium tin oxide (ITO).

The alignment film 105 is a film that aligns molecules of the liquid crystal 120 in a predetermined orientation. The alignment film 105 is formed of, for example, polyimide.

The array substrate 150 (TFT substrate) includes a glass substrate 108. A TFT array 111 is formed on the front surface of the glass substrate 108. The TFT array 111 controls a voltage applied to the liquid crystal 120. An alignment film 112 is formed on the front surface of the TFT array 111. In addition, a polarizing plate 109 is arranged on the back surface of the glass substrate 108. The polarizing plate 109 is attached to the glass substrate 108 via an adhesive (not shown).

The TFT array 111 includes a pixel electrode, a switching element, an insulating film, a gate wiring line, a source wiring line, and the like. The pixel electrode is an electrode for applying a voltage to the liquid crystal 120. The switching element is a TFT for controlling a voltage to be applied to the liquid crystal 120. The insulating film is a film for covering the switching element. The gate wiring line and the source wiring line are wiring lines for supplying a signal to the switching element.

The TFT array 111 is electrically connected to the control board 80. The control board 80 is provided outside the display panel 100.

The alignment film 112 has the same configuration as the alignment film 105.

The color filter substrate 140 and the array substrate 150 are bonded to each other with a sealing material (not shown). The sealing material is provided in the rim portion of each of the color filter substrate 140 and the array substrate 150. In addition, a gap material is provided between the color filter substrate 140 and the array substrate 150 so that the distance between the color filter substrate 140 and the array substrate 150 is constant.

The liquid crystal 120 is surrounded by a sealing material. In addition, the liquid crystal 120 is injected into a region between the color filter substrate 140 and the array substrate 150.

(Backlight)

Next, the backlight 30 will be described. As the backlight 30, a surface light source or the like is used. The surface light source includes, for example, a plurality of point light sources such as light emitting diodes. In addition, the surface light source includes, for example, a point light source such as a light emitting diode and a light guide plate. In addition, the surface light source includes, for example, a line light source such as a fluorescent tube and a resin light guide plate. In addition, the surface light source is, for example, a light source using an electroluminescence element.

(Control Board)

Next, the control board 80 will be described. The control board 80 controls the display panel 100. Specifically, the control board 80 includes a driving integrated circuit (IC) or the like that transmits a driving signal. The control board 80 drives the liquid crystal 120 by controlling the operation of the TFT array 111 of the display panel 100. In addition, the control board 80 also controls the backlight 30.

The control board 80 is electrically connected to the display panel 100 via a flexible flat cable (FPC) 81. The FFC 81 is also referred to as a flexible cable. In addition, the control board 80 is electrically connected to the backlight 30.

As shown in FIG. 2, the backlight 30 and the control board (not shown) are arranged on the back surface side of the display panel 100. The backlight 30 and the control board (not shown) are arranged at a position away from the back surface of the display panel 100. In addition, the backlight 30 and the control board (not shown) are housed in the housing 40 together with the display panel 100 and the touch panel 200.

The housing 40 is made of metal or an opaque resin. The shape of the housing 40 is frame-shaped. The housing 40 is formed so as to cover an outer peripheral portion of movable unit 300 including the touch panel 200 and the display panel 100. The housing 40 includes an upper frame 40a and a side surface portion 40b. The shape of the side surface portion 40b is cylindrical. The side surface portion 40b faces the side surface of the protective plate 220. In FIG. 2, the side surface portion 40b faces the side surface S2a of the protective plate 220. The upper frame 40a covers an end portion of the front surface 22a of the protective plate 220.

(Touch Panel)

Next, the touch panel 200 will be described in detail. The touch panel 200 according to the present embodiment is, for example, a projected capacitive touch panel (hereinafter, also referred to as “PCAP”). The PCAP includes a combination of a plurality of transparent electrodes patterned in the longitudinal direction and the lateral direction. In addition, when an operator such as a finger is brought close to the surface of the PCAP, a capacitance change occurs in an electrode in a portion near the operator. The PCAP identifies the position of the operator by detecting the capacitance change.

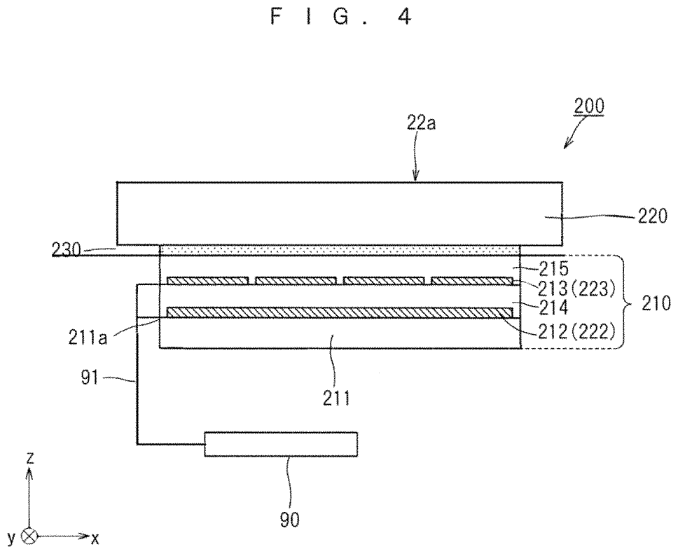

As shown in FIG. 2, the touch panel 200 mainly includes a touch sensor substrate 210 and a protective plate 220. FIG. 4 is a diagram showing a detailed configuration of the touch panel 200 according to the first embodiment.

The touch sensor substrate 210 includes a substrate 211, an excitation electrode 212, a detection electrode 213, an interlayer insulating layer 214, and an insulating layer 215. The substrate 211 is transparent and has an insulating property. The substrate 211 is made of glass, acrylic resin, or the like.

The touch sensor substrate 210 is electrically connected to the touch detection circuit 90 with a flexible print circuit (FPC) 91. The FPC 91 is also referred to as a flexible substrate or a flexible printed circuit board. The touch detection circuit 90 is a circuit for detecting a touched position.

The touch detection circuit 90 is provided on the back surface of a backlight (not shown) together with the control board 80. The touch detection circuit 90 includes, for example, a detection IC and a microcomputer. The detection IC is an IC for detecting a change in capacitance due to a touch. The touch detection circuit 90 detects a touched position on the touch panel 200. Specifically, the touch detection circuit 90 detects a touched position on the front surface 22a of the protective plate 220.

It should be noted that the PCAP of the present embodiment can detect the touched position even in a configuration in which the thickness of the protective plate 220 covering the front surface of the touch sensor substrate 210 is about several mm.

The configuration of the touch sensor substrate 210 will be described in more detail. The touch sensor substrate 210 includes a plurality of row direction wiring line layers 222 and a plurality of column direction wiring line layers 223. The row direction wiring line layer 222 includes a plurality of excitation electrodes 212 electrically connected to each other. The column direction wiring line layer 223 includes a plurality of detection electrodes 213 electrically connected to each other.

The excitation electrode 212 includes a single-layer film or a multilayer film of metal. It should be noted that the excitation electrode 212 may have a multilayer structure not only including any one of a single-layer film and a multilayer film but also using even other conductive materials. The metal is preferably a low-resistance metal such as aluminum or silver. The detection electrode 213 is also similar to the excitation electrode 212. Using metal as the wiring material of the detection electrode 213 allows the wiring resistance to be reduced.

On the other hand, since the metal wiring line is opaque, the metal wiring line is easily visually recognized. In order to lower the visibility, and to increase the transmittance of the touch sensor substrate 210, a thin line structure may be assigned to the metal wiring line. The thin line structure is typically a mesh-shaped structure.

Each of the plurality of row direction wiring line layers 222 extends along the row direction (x-axis direction in FIG. 4). Each of the plurality of column-direction wiring line layers 223 extends along the column direction (y-axis direction in FIG. 4). The plurality of row direction wiring line layers 222 are arranged at intervals in the column direction. The plurality of column direction wiring line layers 223 are arranged at intervals in the row direction.

In a plan view (xy plane), each of the plurality of row direction wiring line layers 222 intersects with the plurality of column direction wiring line layers 223. In addition, in a plan view (xy plane), each of the plurality of column direction wiring line layers 223 intersects with the plurality of row direction wiring line layers 222. The row direction wiring line layer 222 and the column direction wiring line layer 223 are insulated by an interlayer insulating layer 214.

The interlayer insulating layer 214 includes a single-layer film of an organic insulating film or an inorganic insulating film. It should be noted that the interlayer insulating layer 214 may include a multilayer film of an organic insulating film or an inorganic insulating film. The inorganic insulating film is excellent for improving the moisture resistance, and the organic insulating film is excellent for improving the flatness. The inorganic insulating film is, for example, a transparent silicon-based inorganic insulating film or a transparent inorganic insulating film. The transparent silicon-based inorganic insulating film is a silicon oxide film, a silicon nitride film, a silicon oxynitride film, or the like. The transparent inorganic insulating film is made of a metal oxide such as alumina.

The material of the organic insulating film is a polymer material or a thermosetting resin. The polymer material has a main chain and an organic substance bonded to a side chain of the main chain or a functional group. The main chain is made of silicon oxide, a silicon nitride film, a silicon oxynitride film, or the like. The thermosetting resin has a main chain made of carbon. The material of the organic insulating film is, for example, an acrylic resin, a polyimide resin, an epoxy resin, a novolac resin, an olefin resin, or the like.

Each of the row direction wiring line layer 222 and the column direction wiring line layer 223 is connected to the substrate terminal portion 211a by a lead-out wiring line layer (not shown). The lead-out wiring line layer is disposed outside an area where the touch sensor substrate 210 can detect a touched position.

The insulating layer 215 is provided above the substrate 211 so that the substrate terminal portion 211a is exposed. The insulating layer 215 covers the row direction wiring line layer 222, the interlayer insulating layer 214, and the column direction wiring line layer 223. The insulating layer 215 is made of the same material as the interlayer insulating layer 214.

In addition, the structure of the touch sensor substrate 210 may be a structure other than the above structure (hereinafter, also referred to as a “structure A”). In the structure A, the row direction wiring line layer 222 and the column direction wiring line layer 223 are disposed in the same layer. In addition, in the structure A, each of the plurality of column direction wiring line layers 223 includes a plurality of diamond-shaped electrodes as the detection electrodes 213. In addition, in the structure A, the row direction wiring line layer 222 includes a plurality of diamond-shaped electrodes as the excitation electrodes 212.

A material constituting the row direction wiring line layer 222 and the column direction wiring line layer 223 is, for example, a transparent conductive film such as indium tin oxide. Since ITO has translucency, the possibility that the wiring line layer is visually recognized by the user is reduced. A transparent conductive film such as ITO has relatively high electrical resistance. Therefore, the transparent conductive film is desirably applied to a small touch panel in which wiring line resistance is not a problem. It should be noted that corrosion between the transparent conductive film and another metal wiring line is likely to cause disconnection of the wiring line of the transparent conductive film. Thus, in order to prevent corrosion, consideration of moisture resistance and waterproofness is required.

(Vibrating Element)

Next, the vibrating element 50 will be described. As shown in FIGS. 1 and 2, the vibrating element 50 is bonded to the back surface 22b of the protective plate 220 with a double-sided tape or an adhesive.

In the present embodiment, the vibrating element 50 is arranged such that the direction of vibration generated by the vibrating element 50 is the y-axis direction in FIGS. 1 and 2. As described above, the direction of vibration generated by the vibrating element 50 is also referred to as a “vibration direction”.

It should be noted that when the vibration direction coincides with the y-axis direction, the arrangement position of the vibrating element 50 is not limited to the positions shown in FIGS. 1 and 2. For example, the position where the vibrating element 50 is arranged may be another position as long as the position is a position away from the region with which the support 7 is in contact in the side surface S2a of the protective plate 220. In addition, the appearance shape of the vibrating element 50, the number of vibrating elements 50, and the like can also be optionally selected.

In the present embodiment, the vibrating element 50 is, for example, a linear vibrator. The linear vibrator generates an electromagnetic force by a current, and vibrates the coil itself up and down using a repulsive force between the electromagnetic force and the magnet. The frequency of the vibration is about 150 Hz, and the response time is about 20 ms to 30 ms. It should be noted that the vibrating element 50 is not limited to a linear vibrator, and may be a piezoelectric element, an eccentric motor, or the like. The vibrating element 50 is driven by a driving signal output from a drive control unit (not shown).

(Support)

Next, the support 7 will be described. The support 7 of the present embodiment is a bearing. The bearing has a function of receiving a load generated by the motion of the touch panel 200. The motion of the touch panel 200 is, for example, a reciprocating motion, a rotational motion, or the like. In addition, the bearing has a configuration using a ball. That is, the support 7 is a ball bearing.

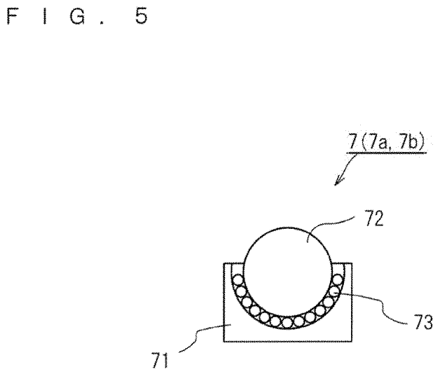

FIG. 5 is a cross-sectional view showing a configuration of the support 7 according to the first embodiment. Referring to FIG. 5, the support 7 includes a cage 71, a main ball 72, and a plurality of sub balls 73. The support 7 is configured such that the main ball 72 is rotatable. Specifically, a plurality of sub balls 73 are provided between the main ball 72 and the cage 71. This configuration can change sliding contact to rolling contact to reduce friction.

The material constituting the main ball 72 and the sub ball 73 is a high carbon chromium bearing steel, a stainless bearing steel, another alloy steel, or the like. The material constituting the cage 71 is a strip steel, a stainless steel plate, a brass plate, plastic, or the like. It should be noted that as the support 7, a ceramic bearing made of silicon nitride, a resin bearing, or the like may be used.

Here, for example, it is assumed that the support 7 is in contact with the back surface 22b of the protective plate 220. In this case, the protective plate 220 is smoothly movable in a direction along the back surface 22b (for example, xy plane) by rotation of the main ball 72.

Hereinafter, “the main ball 72 of the support 7 is in contact with the member” may be simply expressed as “the support 7 is in contact with the member” or “the support 7 supports the member”.

(Characteristic Configuration)

Next, a characteristic configuration of the present embodiment will be described. It should be noted that in the display apparatus 1000 of the present embodiment, there exist three directions orthogonal to each other. Hereinafter, three directions orthogonal to each other existing in the display apparatus 1000 are also referred to as “three directions of the display apparatus”.

The three directions of the display apparatus include an x-axis direction, a y-axis direction, and a z-axis direction. Each of the x-axis direction and the y-axis direction is a direction along the display surface 100a. The x-axis direction and the y-axis direction are orthogonal to each other. The z-axis direction is a direction orthogonal to the display surface 100a.

The display apparatus 1000 of the present embodiment includes a plurality of supports 7 configured so that the touch panel 200 (movable unit 300) does not move in two directions included in three directions of the display apparatus. Hereinafter, two directions included in the three directions of the display apparatus are also referred to as “two non-motion directions”. In the present embodiment, the two non-motion directions are the x-axis direction and the z-axis direction.

In addition, hereinafter, among the three directions of the display apparatus, the direction other than the two non-motion directions is also referred to as a “movable direction”. In the present embodiment, the movable direction is the y-axis direction. In the present embodiment, the movable direction coincides with a vibration direction (y-axis direction) being a direction of vibration generated in the touch panel 200 by the vibrating element 50.

In addition, hereinafter, the plurality of supports 7 included in the display apparatus 1000 is also referred to as “k supports 7”. The k is an integer of 3 or more. In the present embodiment, k is 12, for example.

As shown in FIG. 1, the protective plate 220 is provided with four support pairs 7pa. Specifically, four support pairs 7pa are provided at the respective four corner portions of the protective plate 220 of the touch panel 200. Each of the four support pairs 7pa includes two supports 7a included in the k supports 7 (see FIG. 2). Each of the four support pairs 7pa sandwiches the protective plate 220 in the thickness direction of the protective plate 220. Specifically, the two supports 7a of each of the four support pairs 7pa sandwich the protective plate 220 in the thickness direction of the protective plate 220. The two supports 7a sandwich the protective plate 220 by point contact.

As described above, two supports 7a of each of the four support pairs 7pa are configured so that the touch panel 200 (protective plate 220) does not move in the z-axis direction. That is, two supports 7a of each of the four support pairs 7pa block the motion of the touch panel 200 (protective plate 220) in the z-axis direction. That is, the motion of the movable unit 300 in the z-axis direction is blocked.

It should be noted that the number of support pairs 7pa provided on the protective plate 220 is not limited to 4. The number of support pairs 7pa provided on the protective plate 220 may be 2, 3, or 5 or more.

In addition, as shown in FIG. 1, the protective plate 220 is provided with two support pairs 7pb. Each of the two support pairs 7pb includes two supports 7b included in the k supports 7. Each of the two support pairs 7pb sandwiches two side surfaces S2a of the protective plate 220. Specifically, the two supports 7b of each of the two support pairs 7pb sandwich the two side surfaces S2a. The two supports 7b sandwich the protective plate 220 by point contact.

As described above, two supports 7b of each of the two support pairs 7pb are configured so that the touch panel 200 (protective plate 220) does not move in the x-axis direction. That is, two supports 7b of each of the two support pairs 7pb block the motion of the touch panel 200 (protective plate 220) in the x-axis direction. That is, the motion of the movable unit 300 in the x-axis direction is blocked.

It should be noted that the number of support pairs 7pb provided on the protective plate 220 is not limited to 2. The number of support pairs 7pb provided on the protective plate 220 may be 3 or more.

Hereinafter, the two supports 7a included in the support pair 7pa are also referred to as “two supports 7a forming a pair”. In addition, hereinafter, the two supports 7b included in the support pair 7pb are also referred to as “two supports 7b forming a pair”.

As shown in FIG. 2, the two supports 7a forming a pair in the support pair 7pa include a support 7a in contact with the front surface 22a of the protective plate 220. Hereinafter, the support 7a in contact with the front surface 22a of the protective plate 220 is also referred to as a “support 7a on the front surface side”. The k supports 7 include a support 7a on the front surface side. In addition, the two supports 7a forming a pair include a support 7a in contact with the back surface 22b of the protective plate 220. Hereinafter, the support 7a in contact with the back surface 22b of the protective plate 220 is also referred to as a “support 7a on the back surface side”.

The support 7a on the front surface side is embedded in the upper frame 40a of the housing 40. The support 7a on the front surface side supports the touch panel 200 (protective plate 220) by point contact. Specifically, the support 7a (main ball 72) on the front surface side is in point contact with the front surface 22a of the protective plate 220.

The support 7a on the back surface side is disposed on the frame 60. The support 7a on the back surface side supports the touch panel 200 (protective plate 220) by point contact. Specifically, the support 7a on the back surface side supports the back surface 22b of the protective plate 220. That is, the support 7a on the back surface side supports the weight of the movable unit 300 including the touch panel 200 and the display panel 100. The k supports 7 include the support 7a on the back surface side.

Hereinafter, the two supports 7b included in the support pair 7pb are also referred to as “two supports 7b forming a pair”. As shown in FIG. 1, the two respective supports 7b forming a pair support two side surfaces S2a of the protective plate 220. In addition, the two respective supports 7b forming a pair are in point contact with the two side surfaces S2a. The two supports 7b forming a pair support the touch panel 200 (protective plate 220) by point contact.

Hereinafter, the support 7b in contact with the side surface S2a of the protective plate 220 is also referred to as a “support 7b on the side surface side”. The support 7b on the side surface side is embedded in the side surface portion 40b of the housing 40. The support 7b on the side surface side supports the touch panel 200 (protective plate 220) by point contact. Specifically, the support 7b on the side surface side is in point contact with the side surface S2a of the protective plate 220.

The k supports 7 are arranged as described above with reference to FIGS. 1 and 2. Thus, the touch panel 200 is configured so that the touch panel 200 (protective plate 220) is movable in the vibration direction. Therefore, the movable unit 300 is movable in the vibration direction. The length of the range in which the touch panel 200 (protective plate 220) is movable in the vibration direction is 1 mm or less, and desirably ranges from 10 μm to 500 μm. It should be noted that the positions at which the k supports 7 are arranged are not limited to the positions shown in FIGS. 1 and 2.

Here, a comparative example to be compared with the present embodiment will be described. Hereinafter, the display apparatus as a comparative example is also referred to as a “display apparatus J1”. The display apparatus J1 differs from the display apparatus 1000 in the positions at which the k supports 7 are arranged. In the display apparatus J1, k supports 7 are arranged at unfavorable positions.

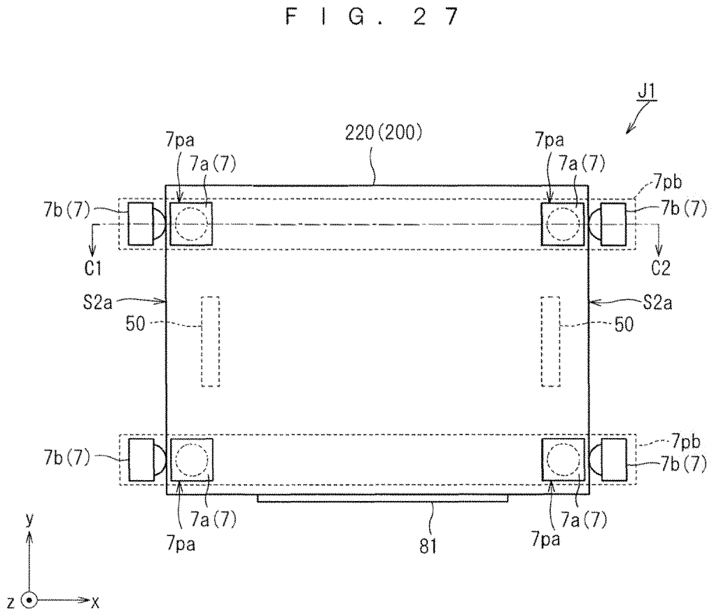

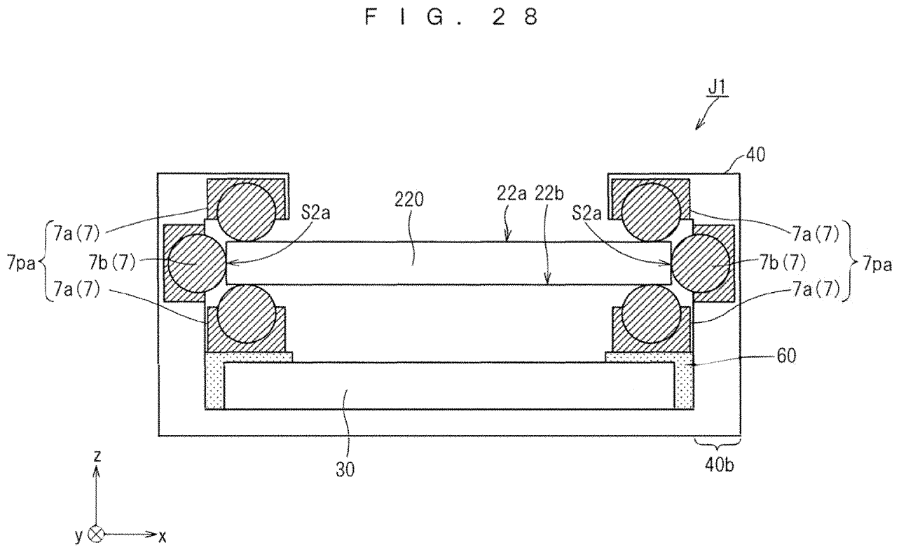

FIG. 27 is a plan view of a display apparatus J1 as a comparative example. It should be noted that in FIG. 27, as in FIG. 1, the housing 40 is not shown. FIG. 28 is a cross-sectional view of the display apparatus J1 taken along line C1-C2 in FIG. 27. It should be noted that in FIG. 28, some components (for example, the display panel 100 and the touch sensor substrate 210) included in the display apparatus J1 are not shown for easy understanding of the configuration.

Referring to FIG. 27, the display apparatus J1 includes four support pairs 7pa and two support pairs 7pb. It should be noted that the configuration and function of each support pair 7pa in the display apparatus J1 are the same as the configuration and function of each support pair 7pa in the display apparatus 1000. The configuration and function of each support pair 7pb in the display apparatus J1 are the same as the configuration and function of each support pair 7pb in the display apparatus 1000.

The display apparatus J1 differs from the display apparatus 1000 in FIG. 1 only in the positions of the two support pairs 7pb. As shown in FIG. 27, in the display apparatus J1, two supports 7b constituting the support pair 7pb and two support pairs 7pa are linearly arranged in the X-axis direction of the protective plate 220. In this case, as shown in FIG. 28, the distance between the two supports 7a of the support pair 7pa and the support 7b becomes very small. Depending on the size of the support 7, at least two supports 7 may come into contact. Therefore, the two supports 7b constituting the support pair 7pb and the support pair 7pa need to be arranged at intervals so as not to contact each other.

It should be noted that the number of supports 7 included in the display apparatus 1000 is not limited to the number of supports 7 shown in FIGS. 1 and 2.

Here, it is assumed that the number of support pairs 7pa included in the display apparatus 1000 is 2. In this case, rotational motion occurs on the protective plate 220 with a straight line connecting the two support pairs 7pa as the rotation axis. In addition, it is assumed that the number of support pairs 7pb included in the display apparatus 1000 is 1. In this case, rotational motion occurs on the protective plate 220 with a straight line connecting the two support pairs 7pb constituting the support pair 7pb as the rotation axis.

Therefore, the number of supports 7 needs to be set to the number for reliably blocking the occurrence of parallel motion, rotational motion, and the like in the supporting direction. In addition, it is necessary to consider the arrangement portions of the k supports 7 so that the protective plate 220 is stably supported.

As described above, the motion of the touch panel 200 (protective plate 220) in the z-axis direction is blocked by the four support pairs 7pa. In addition, the motion of the touch panel 200 (protective plate 220) in the x-axis direction is blocked by the two supports 7b. The touch panel 200 (protective plate 220) can freely move only in the y-axis direction among the three directions (x-axis direction, y-axis direction, and z-axis direction). That is, the movable unit 300 can freely move only in the y-axis direction.

In addition, the vibrating element 50 causes the touch panel 200 (protective plate 220) to vibrate along the y-axis direction. It should be noted that the main ball 72 of the support 7 is in contact with the protective plate 220 at one point. In addition, as shown in FIG. 5, since the main ball 72 is in rolling contact with the sub ball 73, frictional resistance is very small. Therefore, the touch panel 200 (protective plate 220) can smoothly move in the y-axis direction according to the vibration generated by the vibrating element 50. That is, the movable unit 300 can smoothly move in the y-axis direction.

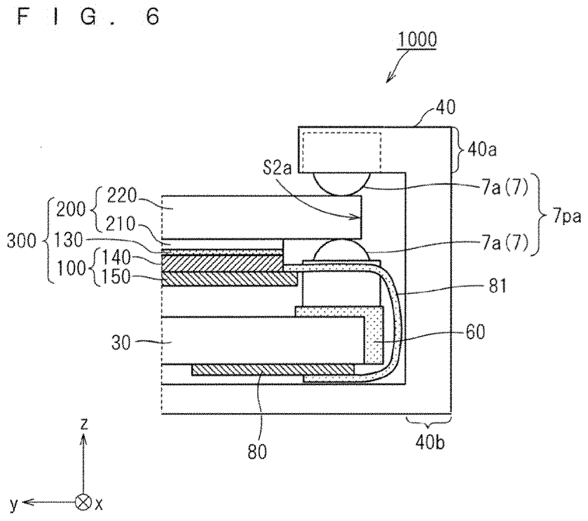

FIG. 6 is a cross-sectional view of the display apparatus 1000 taken along line B1-B2 in FIG. 1. It should be noted that, in FIG. 6, in order to make the configuration easy to understand, components (for example, support 7a) that do not exist at the position of the line B1-B2 in FIG. 1 are also shown.

As shown in FIG. 6, a control board 80 that controls the display panel 100 is provided on the back surface of the backlight 30. It should be noted that in the vibration direction (y-axis direction), there is a space for allowing the protective plate 220 to move between the side surface S2a of the protective plate 220 and the side surface portion 40b of the housing 40. The space is a region that does not hinder the motion of the protective plate 220 in the vibration direction. That is, the housing 40 is configured such that the protective plate 220 is movable in the vibration direction (y-axis direction).

As described above, the display panel 100 is electrically connected to the control board 80 via the FFC 81. That is, the control board 80 and the display panel 100 are connected to each other with the FFC 81 (flexible cable).

As shown in FIG. 1, the FFC 81 is taken out in the −y direction (lower side in the figure) of the display apparatus 1000. In addition, as shown in FIG. 6, the FFC 81 passes through the outside of the end portion of the backlight 30 and is connected to the control board 80 provided on the back surface of the backlight 30. It should be noted that the array substrate 150 and the control substrate 80 are not connected at the minimum distance by the FFC 81. The control board 80 is provided such that the FFC 81 has a deflection of about several mm. It should be noted that the touch panel 200 is bonded to the display panel 100. That is, the FFC 81 (flexible cable) is configured so that the touch panel 200 (movable unit 300) is movable in the vibration direction (y-axis direction).

Accordingly, when the touch panel 200 vibrates in the y-axis direction, the FFC 81 does not block or suppress the motion of the touch panel 200 (movable unit 300). Thus, the touch panel 200 (movable unit 300) can move smoothly.

Here, it is assumed that the FFC 81 is taken out in the x direction in FIG. 1. In this case, when the touch panel 200 vibrates in the y-axis direction, the FFC 81 slightly suppresses the motion of the touch panel 200 (movable unit 300). Therefore, the FFC 81 is desirably taken out in the −y direction in FIG. 1.

In addition, the connection between the touch sensor substrate 210 and the touch detection circuit 90 by the FPC 91 (flexible substrate) described in FIG. 4 is also similar to the configuration of the FFC 81 in FIG. 6. The FPC 91 is desirably taken out in the −y direction in FIG. 1. The touch detection circuit 90 is provided on the back surface of the backlight 30 so that the FPC 91 has a deflection of about several mm. The touch detection circuit 90 and the touch panel 200 (touch sensor substrate 210) are connected to each other with an FPC 91 (flexible substrate). The FPC 91 (flexible substrate) is configured so that the touch panel 200 (touch sensor substrate 210) is movable in the vibration direction (y-axis direction). That is, the FPC 91 is configured so that the movable unit 300 is movable in the vibration direction.

It should be noted that when the FFC 81 and the FPC 91 interfere with each other in a situation where the FFC 81 and the FPC 91 are taken out in the same direction, it is preferable to perform as follows. For example, the FFC 81 is taken out in the −y direction, and the FPC 91 is taken out in the y direction. In addition, for example, the FFC 81 is taken out in the y direction, and the FPC 91 is taken out in the −y direction.

By the way, a display apparatus mounted with a touch panel is also used in automatic ticket machines, vending machines, FA apparatuses, and the like. In many of these apparatuses, a display apparatus is installed in an erected state, and a display surface along a vertical direction is touched and used.

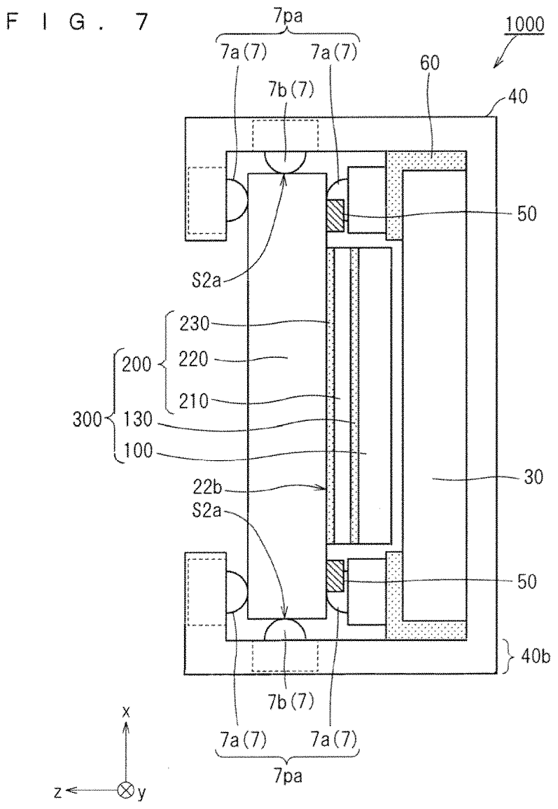

FIG. 7 is a cross-sectional view of the display apparatus 1000 in an erected state according to the first embodiment. In the configuration in FIG. 7, the weight of the movable unit 300 including the touch panel 200 and the display panel 100 is applied to the side surface S2a of the protective plate 220. The support 7b embedded in the side surface portion 40b (bottom surface side in FIG. 7) of the housing 40 comes into contact with the side surface S2a of the protective plate 220. Thus, the support 7b supports the movable unit 300 including the touch panel 200 and the display panel 100. The support 7b is one of the two supports 7b forming a pair included in the support pair 7pb.

The other support 7b of the two supports 7b forming a pair is in contact with another side surface S2a of the protective plate 220. The motion of the touch panel 200 (protective plate 220) in the x-axis direction is blocked by the two supports 7b forming a pair. That is, the motion of the movable unit 300 in the x-axis direction is blocked.

In addition, similarly to FIG. 2, the two supports 7a of the support pair 7pa sandwich the protective plate 220 in the thickness direction of the protective plate 220. Thus, the motion of the touch panel 200 (protective plate 220) in the z-axis direction is blocked. That is, the motion of the movable unit 300 in the z-axis direction is blocked.

The vibrating element 50 bonded to the back surface 22b of the protective plate 220 generates vibration in the y-axis direction. Therefore, even when the display apparatus 1000 is erected and used, the weight of the protective plate 220 is supported by the support 7b. In addition, the motion of the touch panel 200 (protective plate 220) in the x-axis direction and the z-axis direction is blocked by the two supports 7b and the support pair 7pa. Therefore, the touch panel 200 (protective plate 220) can freely move in the y-axis direction being the generation direction of the vibration. That is, the movable unit 300 can freely move in the y-axis direction being the generation direction of the vibration.

In the display apparatus 1000 having the above configuration, when the touch detection circuit 90 detects that an operator such as a user's finger touches the protective plate 220 of the touch panel 200, the following processing is performed. In the processing, the vibrating element 50 is driven by a driving signal output from a drive control unit (not shown). Thus, the vibrating element 50 vibrates the touch panel 200 to give a tactile sensation to the user.

As described above, according to the present embodiment, the vibrating element 50 causes the touch panel 200 to vibrate. In the display apparatus 1000, there exist three directions including an x-axis direction and a y-axis direction along the display surface 100a and a z-axis direction orthogonal to the display surface 100a. The plurality of supports 7 are configured such that touch panel 200 does not move in the x-axis direction and the z-axis direction being two directions included in the three directions. Of the three directions, the direction other than the two directions coincides with a vibration direction being a direction of vibration generated by the vibrating element 50. The touch panel 200 is configured so that the touch panel 200 is configured to move in the vibration direction.

Thus, the propagation in the above two directions of the vibration generated in the touch panel by the vibrating element is suppressed. Therefore, it is possible to suppress the reduction in the energy of vibration generated in the touch panel by the vibrating element.

That is, according to the present embodiment, in the display apparatus 1000 mounted with the tactile touch panel (touch panel 200) in the vibration method, the display panel and the touch panel arranged at positions away from the backlight are supported by a plurality of supports 7 from the two directions. In addition, the motion of the touch panel 200 (protective plate 220) in the two directions (the x-axis direction and the z-axis direction) is blocked. The direction in which the motion is not blocked coincides with the direction of vibration (vibration direction) generated in the touch panel 200 by the vibrating element 50.

Thus, it is possible to suppress the dispersion of the vibration force (energy) generated in the touch panel 200 in multiple directions. Therefore, it is possible to obtain an effect of efficiently generating vibration in the touch panel 200 with a small force.

In addition, according to the present embodiment, as described with reference to FIG. 7, even when the display apparatus is erected and used, the touch panel can be stably supported, and the touch panel can be efficiently vibrated.

In addition, according to the present embodiment, the support 7 supports the touch panel 200 (protective plate 220) by point contact. Thus, frictional resistance is reduced. Therefore, it is possible to achieve a touch panel that efficiently vibrates with a small force.

In addition, according to the present embodiment, the two supports 7a of each of the four support pairs 7pa sandwich the protective plate 220 in the thickness direction of the protective plate 220. The two supports 7b of each of the two support pairs 7pb sandwich the two side surfaces S2a.

Thus, the motion of the touch panel 200 (protective plate 220) in the two directions (z-axis direction, x-axis direction) is reliably blocked. In addition, the protective plate 220 can be stably supported. Therefore, it is possible to achieve a touch panel that efficiently vibrates with a small force.

In addition, according to the present embodiment, the support 7 is a bearing having a function of receiving a load generated by the motion of the touch panel 200. Thus, it is possible to support the load of the touch panel, and to efficiently vibrate the touch panel with a small force in the movable direction of the touch panel.

In addition, according to the present embodiment, the support 7a on the back surface side supports the back surface 22b of the protective plate 220. Thus, the touch panel can be stably supported. Therefore, it is possible to efficiently vibrate a touch panel with a small force in the vibration direction.

In addition, according to the present embodiment, the two respective supports 7b forming a pair support the two side surfaces S2a of the protective plate 220. Thus, the touch panel can be stably supported. Therefore, it is possible to efficiently vibrate a touch panel with a small force in the vibration direction.

In addition, according to the present embodiment, the FFC 81 (flexible cable) is configured so that the touch panel 200 is configured to move in the vibration direction (y-axis direction). In addition, the FPC 91 (flexible substrate) is configured so that the touch panel 200 (touch sensor substrate 210) is configured to move in the vibration direction (y-axis direction). Thus, the touch panel (movable unit 300) can smoothly move without blocking or suppressing the motion of the touch panel (movable unit 300).

It should be noted that as described above, in the related configuration A, the vibration generated in the touch panel by the vibrating element propagates in various directions, and the energy of the vibration is dispersed. This may reduce vibration efficiency.

In addition, in the related configuration A, only an elastic support member such as a leaf spring is provided between the backlight and the protective plate separated from each other. Therefore, there is a problem that when the display apparatus is erected and used, the following trouble easily occurs. The trouble is, for example, a trouble that the protective plate is not stably supported. In addition, the trouble is a trouble that the weight of the touch panel makes it difficult to generate vibration.

Thus, the display apparatus 1000 of the present embodiment has a configuration for producing the above-described effect. Therefore, the above problems can be solved by the display apparatus 1000 of the present embodiment.

<First Modification>

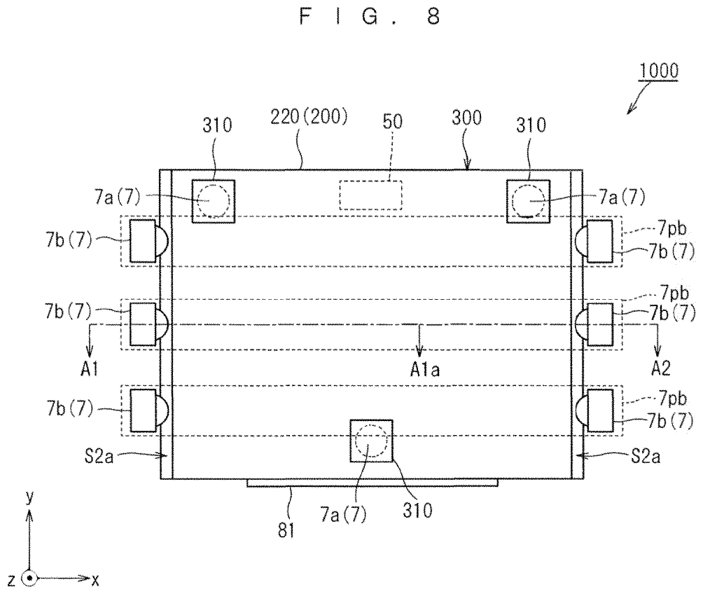

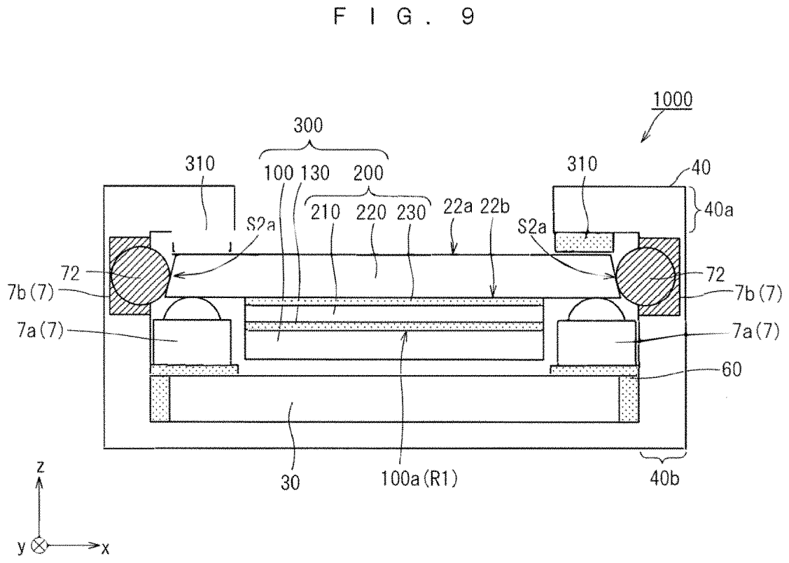

The configuration of the present modification is applied to the first embodiment. FIG. 8 is a plan view of a display apparatus 1000 having the configuration of the first modification. FIG. 9 is a cross-sectional view of the display apparatus 1000 taken along line A1-A2 in FIG. 8. It should be noted that in FIG. 9, in order to facilitate understanding of the configuration, components not present at the position of the line A1-A2 in FIG. 8 (for example, the support 7a, and a cushion material 310 described below) are also shown.

Referring to FIGS. 8 and 9, the configuration of the present modification differs from the configuration of the first embodiment mainly in the shape of the protective plate 220, the structure for supporting the protective plate 220, the arrangement of the support, and the like. In addition, in the configuration of the present modification, the protective plate 220 is provided with three support pairs 7pb. In addition, in the configuration of the present modification, the protective plate 220 is provided with three supports 7a instead of the four support pairs 7pa. The configuration other than that of the present modification is similar to the configuration of the first embodiment.

In the present modification, each of the two side surfaces S2a of the protective plate 220 is an inclined surface. Each of the three support pairs 7pb sandwiches two side surfaces S2a of the protective plate 220. Specifically, the two supports 7b of each of the three support pairs 7pb sandwich the two side surfaces S2a.

It should be noted that the two supports 7b sandwich the protective plate 220 by point contact. That is, two supports 7b of each of the three support pairs 7pb are configured so that the touch panel 200 (protective plate 220) does not move in the x-axis direction. That is, two supports 7b of each of the three support pairs 7pb block the motion of the touch panel 200 (protective plate 220) in the x-axis direction. That is, the motion of the movable unit 300 in the x-axis direction is blocked.

In addition, the two respective supports 7b forming a pair support two side surfaces S2a of the protective plate 220. The two respective supports 7b forming a pair are in point contact with the two side surfaces S2a of the protective plate 220. It should be noted that the back surface 22b of the protective plate 220 is supported by the support 7a.

The contour of the side surface S2a of the protective plate 220 includes four sides. A side corresponding to an end of the back surface 22b among the four sides is closer to the support 7b than a side corresponding to an end of the front surface 22a among the four sides. That is, the side on the back surface 22b side among the four sides of the side surface S2a protrudes toward the support 7b from the side on the front surface 22a side among the four sides.

Hereinafter, in the side surface S2a, a region with which the support 7b (main ball 72) is in contact is also referred to as a “contact region”. That is, in the side surface S2a, a region below the contact region protrudes toward the support 7b.

Therefore, the protective plate 220 cannot move upward from the apex of the main ball 72 of the support 7b. That is, the support 7b for supporting the side surface S2a of the protective plate 220 blocks not only the motion in the x-axis direction but also the motion in the z-direction (upward direction) of the touch panel 200 (protective plate 220). That is, the motion of the movable unit 300 in the z direction is also blocked.

Therefore, in the configuration of the present modification, it is not necessary to provide the support 7a in contact with the front surface 22a of the protective plate 220 shown in FIG. 2. However, in order to prevent the protective plate 220 from jumping out upward, a cushion material 310 is provided between the upper frame 40a of the housing 40 and the front surface 22a of the protective plate 220.

The cushion material 310 is bonded to the upper frame 40a of the housing 40 with a double-sided tape or an adhesive. In order that the motion of the protective plate 220 is not blocked, the cushion material 310 is provided so as not to contact the front surface 22a of the protective plate 220. That is, a gap exists between the cushion material 310 and the front surface 22a.

It should be noted that in FIG. 9, the cushion material 310 is provided only above the position of the support 7a that supports the back surface 22b of the protective plate 220, but the cushion material 310 may be provided at places other than this. For example, the cushion material 310 may be provided on the upper frame 40a so that the cushion material 310 covers the entire rim portion of the protective plate 220.

It should be noted that in the configuration in FIG. 8, three supports 7a and three support pairs 7pb are provided.

In the configuration of the present modification, the touch panel 200 can be efficiently vibrated with a small force. Therefore, the number of vibrating elements 50 may be one depending on conditions such as the size of the touch panel and the size of the display panel. FIG. 8 shows a state in which one vibrating element 50 is provided.

In addition, in FIG. 8, the vibrating element 50 is arranged at the central portion of the long side of the protective plate 220, but the present invention is not limited thereto. The vibrating element 50 may be arranged at a position shifted to any one of the left and the right from the central portion of the long side of the protective plate 220.

In the present modification, the touch panel 200 (movable unit 300) is movable only in a direction coincident with the direction of vibration (vibration direction) generated by the vibrating element 50. Therefore, regardless of the position where the vibrating element 50 is arranged, the touch panel 200 (movable unit 300) moves in the vibration direction without the force being dispersed.

As described above, according to the present modification, the shapes of the two side surfaces S2a of the protective plate 220 of the touch panel 200 are inclined surfaces. This makes it possible to achieve a touch panel that efficiently vibrates with a small force without providing a support that supports the front surface 22a of the protective plate 220.

<Second Modification>

The present modification is applied to the first modification. The configuration of the present modification differs from the configuration of the first modification mainly in the shape of the side surface S2a of the protective plate 220. The configuration other than that of the present modification is similar to the configuration of the first modification.

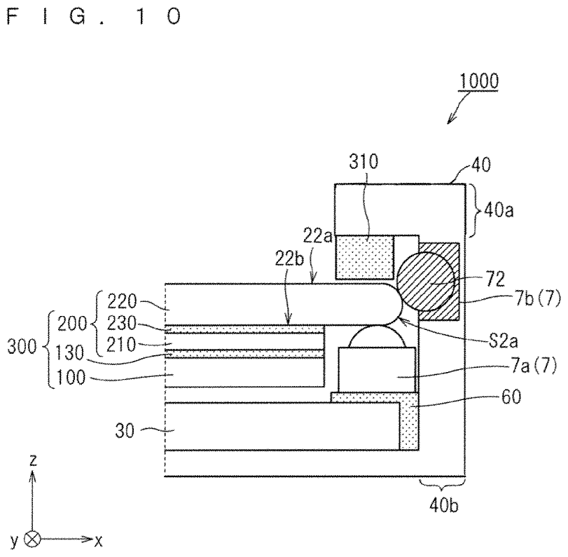

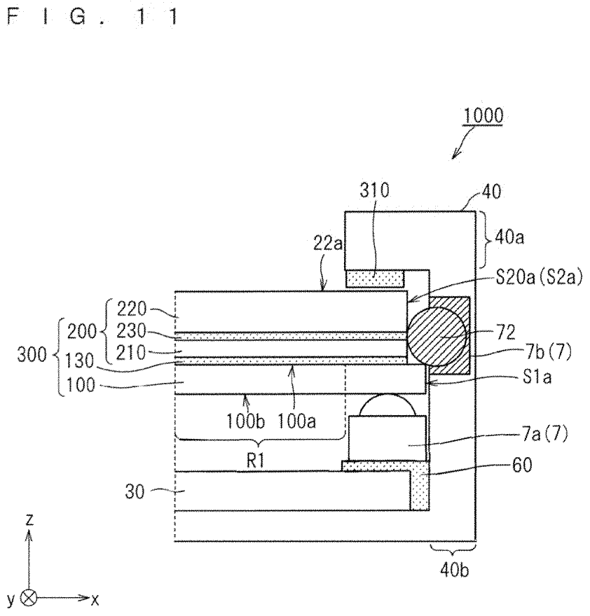

The plan view of the display apparatus 1000 having the configuration of the second modification is the same as that in FIG. 8 except that the end portion shape of the protective plate 220 is different. FIG. 10 is a cross-sectional view of the display apparatus 1000 having the configuration of the second modification taken along line A1a-A2 in FIG. 8. It should be noted that in FIG. 10, in order to make the configuration easy to understand, components not present at the position of the line A1a-A2 in FIG. 8 (for example, the support 7a and the cushion material 310) are also shown. It should be noted that also in FIGS. 11, 12, and 13 described below, components do not present at the position of the line A1a-A2 in FIG. 8 are shown.

The two respective supports 7b forming a pair in the support pair 7pb support the two side surfaces S2a of the protective plate 220. The two respective supports 7b forming a pair are in point contact with the two side surfaces S2a of the protective plate 220. The two supports 7b forming a pair block the motion of the touch panel 200 (protective plate 220) in the x-axis direction. That is, the motion of the movable unit 300 in the x-axis direction is blocked.

In the present modification, the side surface S2a of the protective plate 220 is a curved surface. The side surface S2a is curved such that a part of the side surface S2a approaches the support 7b. That is, the shape of the side surface S2a of the protective plate 220 is convex. The side surface S2a is convex with respect to the yz plane along the thickness direction of the protective plate 220. Hereinafter, the side surface S2a of the protective plate 220 in the present modification is also referred to as a “convex side surface”.

In the present modification, in the side surface S2a (convex side surface), the support 7b comes into contact with a region closer to the front surface 22a than the apex of the side surface S2a. That is, the support 7b contacts a region above the apex of the side surface S2a in the side surface S2a. Hereinafter, in the side surface S2a, a position with which the support 7b (main ball 72) is in contact is also referred to as a “contact position”.

On the other hand, the apex of the side surface S2a of the protective plate 220 protrudes toward the support 7b below the contact position. Therefore, the protective plate 220 cannot move upward from the apex of the main ball 72 of the support 7b. That is, the support 7b for supporting the side surface S2a of the protective plate 220 blocks not only the motion in the x-axis direction but also the motion in the z-direction (upward direction) of the touch panel 200 (protective plate 220). That is, the motion of the movable unit 300 in the z direction is also blocked.

Therefore, in the configuration of the present modification, it is not necessary to provide the support 7a in contact with the front surface 22a of the protective plate 220 shown in FIG. 2. However, in order to prevent the protective plate 220 from jumping out upward, a cushion material 310 is provided between the upper frame 40a of the housing 40 and the front surface 22a of the protective plate 220. The installation method and the installation position of the cushion material 310 are similar to those of the first modification.

It should be noted that the side surface S2a is not limited to a curved surface. The shape of the side surface S2a may be another shape as long as it is a shape protruding toward the support 7b. The side surface S2a may include, for example, two inclined planes.

As described above, according to the present modification, the shape of the side surface S2a of the protective plate 220 is convex. The support 7b contacts a region above the apex of the side surface S2a in the side surface S2a. This makes it possible to achieve a touch panel that efficiently vibrates with a small force without providing a support that supports the front surface 22a of the protective plate 220.

<Third Modification>

The present modification is applied to the first modification. The configuration of the present modification differs from the configuration of the first modification mainly in the shape of the side surface S2a and the support structure of the protective plate 220. The configuration other than that of the present modification is similar to the configuration of the first modification.

The plan view of the display apparatus 1000 having the configuration of the third modification is the same as that in FIG. 8 except that the shape of the side surface S2a of the protective plate 220 is different. FIG. 11 is a cross-sectional view of the display apparatus 1000 having the configuration of the third modification taken along line A1a-A2 in FIG. 8.

The shape of the protective plate 220 of the present modification is the same as the shape of the protective plate 220 of the first embodiment. The shape of the protective plate 220 is a rectangular parallelepiped.

The touch panel 200 has two side surfaces S20a intersecting with the x-axis direction. It should be noted that in FIG. 11, only one of the two side surfaces S20a is shown. The side surface S20a includes a side surface S2a of the protective plate 220 and a side surface of the touch sensor substrate 210.

Hereinafter, the direction intersecting with the two side surfaces S20a of the touch panel 200 is also referred to as an “intersecting direction”. The intersecting direction is the x-axis direction. In addition, the display panel 100 has two side surfaces Sla intersecting with the x-axis direction. It should be noted that in FIG. 11, only one of the two side surfaces Sla is shown.

In the present modification, the side surface Sla of display panel 100 protrudes toward the support 7b from the side surface S20a of the touch panel 200. The length of the display panel 100 in the x-axis direction is larger than the length of the touch panel 200 in the x-axis direction. That is, the length of the touch panel 200 in the x-axis direction is smaller than the length of the display panel 100 in the x-axis direction. That is, the size of the touch panel 200 in the intersecting direction (x-axis direction) is smaller than the size of the display panel 100 in the intersecting direction.

In addition, the length of the protective plate 220 in the x-axis direction is smaller than the length of the display panel 100 in the x-axis direction. In addition, the length of the touch sensor substrate 210 in the x-axis direction is smaller than the length of the display panel 100 in the x-axis direction. Therefore, in the present modification, a part of the display surface 100a of the display panel 100 is the display region R1.

Hereinafter, the back surface of the display panel 100 is also referred to as a “back surface 100b”. The back surface 100b is a surface opposite to the display surface 100a in the display panel 100.

In the present modification, the k supports 7 include a support 7b in contact with the touch panel 200 and the display panel 100. In addition, the support 7a on the back surface side provided on the frame 60 supports the back surface 100b of the display panel 100. The support 7a on the back surface side is in point contact with the back surface 100b. The support 7a on the back surface side supports the weight of the movable unit 300 including the display panel 100 and the touch panel 200. In addition, in the present modification, the k supports 7 include the support 7a on the back surface side described above.

The two respective supports 7b forming a pair in the support pair 7pb support the two side surfaces S20a of the touch panel 200. The two respective supports 7b forming a pair are in point contact with the two side surfaces S20a of the touch panel 200. Thus, the two supports 7b forming a pair block the motion of the touch panel 200 (protective plate 220) in the x-axis direction. That is, the motion of the movable unit 300 in the x-axis direction is blocked.

In addition, one support 7b of the two supports 7b forming a pair supports one or both of the side surface S2a of the protective plate 220 and the side surface of the touch sensor substrate 210. Specifically, the main ball 72 of the one support 7b of the two supports 7b forming a pair contacts one or both of the side surface S2a of the protective plate 220 and the side surface of the touch sensor substrate 210.

In addition, the main ball 72 of the support 7b also contacts an end of the display surface 100a of the display panel 100. Thus, the support 7b also blocks the motion in the z-direction (upward direction) of the touch panel 200 (protective plate 220). That is, the motion of the movable unit 300 in the z direction is also blocked.

That is, the main ball 72 of the support 7b is in contact with the touch panel 200 and the display panel 100 at two points. Thus, the support 7b blocks the motion in the x-axis direction and the z-direction of the touch panel 200 (protective plate 220). That is, the motion in the x-axis direction and the z-direction of the movable unit 300 is blocked. With this structure, the display panel 100 cannot move upward from the tip of the main ball 72 of the support 7b.

Therefore, in the configuration of the present modification, it is not necessary to provide the support 7a in contact with the front surface 22a of the protective plate 220 shown in FIG. 2. However, in order to prevent the protective plate 220 from jumping out upward, a cushion material 310 is provided between the upper frame 40a of the housing 40 and the front surface 22a of the protective plate 220. The installation method and the installation position of the cushion material 310 are similar to those of the first modification.

It should be noted that the display region R1 of the display surface 100a of the display panel 100 exists in a region inside a region where the support 7a on the back surface side is provided.

As described above, according to the present modification, the length of the display panel 100 in the x-axis direction is larger than the length of the touch panel 200 in the x-axis direction. In addition, the support 7b is in contact with the touch panel 200 and the display panel 100 at two points to support the touch panel 200 and the display panel 100. This makes it possible to achieve a touch panel that efficiently vibrates with a small force without providing a support that supports the front surface 22a of the protective plate 220.

In addition, according to the present modification, the support 7a on the back surface side supports the back surface 100b of the display panel 100. Thus, the touch panel to which the display panel is bonded can be stably supported. Therefore, it is possible to efficiently vibrate a touch panel with a small force in the vibration direction.

<Fourth Modification>

The present modification is applied to the first modification. The configuration of the present modification differs from the configuration of the first modification mainly in the shape of the side surface S2a and the support structure of the protective plate 220. The configuration other than that of the present modification is similar to the configuration of the first modification.

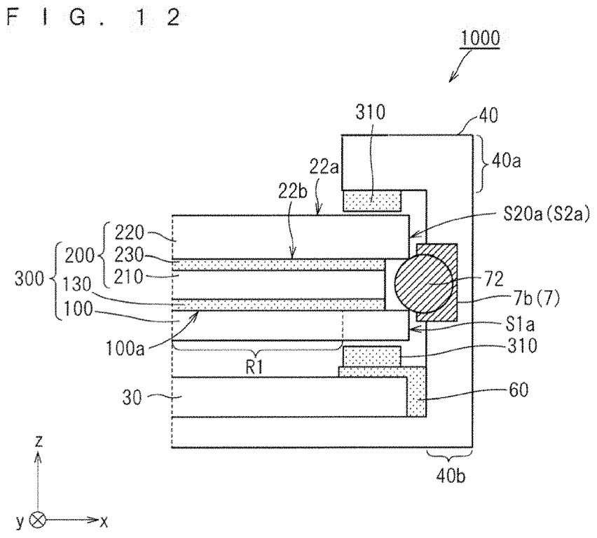

The plan view of the display apparatus 1000 having the configuration of the fourth modification is the same as that in FIG. 8 except that the shape of the side surface S2a of the protective plate 220 is different. FIG. 12 is a cross-sectional view of the display apparatus 1000 having the configuration of the fourth modification taken along line A1a-A2 in FIG. 8.

The shape of the protective plate 220 of the present modification is the same as the shape of the protective plate 220 of the first embodiment. The shape of the protective plate 220 is a rectangular parallelepiped.

It should be noted that as described above, the display panel 100 has two side surfaces Sla intersecting with the x-axis direction. It should be noted that in FIG. 12, only one of the two side surfaces Sla is shown. In addition, as described above, the touch panel 200 has the two side surfaces S20a intersecting with the x-axis direction. It should be noted that in FIG. 12, only one of the two side surfaces S20a is shown. The side surface S20a of the present modification has unevenness. The side surface S20a includes a side surface S2a of the protective plate 220 and a side surface of the touch sensor substrate 210.

As described above, the direction intersecting with the two side surfaces S20a of the touch panel 200 is also referred to as an “intersecting direction”. The intersecting direction is the x-axis direction. In the present modification, as shown in FIG. 12, the side surface S2a of the protective plate 220 and the side surface of the display panel 100 protrude toward the support 7b from the side surface of the touch sensor substrate 210.

The length of the protective plate 220 and the length of the display panel 100 in the x-axis direction are larger than the length of the touch sensor substrate 210 in the x-axis direction. That is, the length of the touch sensor substrate 210 in the x-axis direction is smaller than the length of the display panel 100 in the x-axis direction. In addition, the length of the touch sensor substrate 210 in the x-axis direction is smaller than the length of the protective plate 220 in the x-axis direction.

That is, the size of the protective plate 220 in the intersecting direction (x-axis direction) is larger than the size of the touch sensor substrate 210 in the intersecting direction. The size of the display panel 100 in the intersecting direction is larger than the size of the touch sensor substrate 210 in the intersecting direction. Therefore, in the present modification, a part of the display surface 100a of the display panel 100 is the display region R1.

The two respective supports 7b forming a pair in the support pair 7pb support the two side surfaces S2a of the protective plate 220. In addition, the two respective supports 7b forming a pair in the support pair 7pb support the two side surfaces Sla of the display panel 100.

Specifically, the main ball 72 of one support 7b of the two supports 7b forming a pair contacts the lower end of the side surface S2a of the protective plate 220 and the upper end of the side surface Sla of the display panel 100. Thus, the two supports 7b forming a pair block the motion of the touch panel 200 (protective plate 220) in the x-axis direction. That is, the motion of the movable unit 300 in the x-axis direction is blocked.

That is, in the present modification, the k supports 7 include the support 7b in contact with the protective plate 220 and the display panel 100. Specifically, the main ball 72 of the support 7b is in contact with the side surface S2a of the protective plate 220 and the side surface Sla of the display panel 100. The upper portion of the tip portion of the main ball 72 is in contact with the lower end of the side surface S2a of the protective plate 220. The lower portion of the tip portion of the main ball 72 is in contact with the upper end of the side surface Sla of the display panel 100. Thus, the support 7b also blocks the motion in the z-direction of the touch panel 200 (protective plate 220). That is, the motion of the movable unit 300 in the z direction is also blocked.

That is, the main ball 72 of the support 7b is in contact with the side surface S2a of the protective plate 220 and the side surface Sla of the display panel 100 at two points. Thus, the support 7b blocks the motion in the x-axis direction and the z-direction (z-axis direction) of the touch panel 200 (protective plate 220). That is, the motion in the x-axis direction and the z-direction of the movable unit 300 is blocked. With this structure, the display panel 100 cannot move upward from the tip of the main ball 72 of the support 7b. In addition, the protective plate 220 cannot move downward from the tip of the main ball 72 of the support 7b.

Therefore, in the configuration of the present modification, it is not necessary to provide the support 7a in contact with the front surface 22a of the protective plate 220 shown in FIG. 2. In addition, in the configuration of the present modification, it is not necessary to provide the support 7a on the back surface side existing below the display panel 100 shown in FIG. 11.

However, in order to prevent the protective plate 220 from jumping out upward, a cushion material 310 is provided between the upper frame 40a of the housing 40 and the front surface 22a of the protective plate 220. The installation method and the installation position of the cushion material 310 are similar to those of the first modification.

In addition, another cushion material 310 is provided also below the display panel 100 similarly to the cushion material 310 of the upper frame 40a. It should be noted that the cushion material 310 is provided at a position outside the display region R1 of the display surface 100a of the display panel 100 and at a position hidden under the upper frame 40a.

As described above, according to the present modification, the length of the protective plate 220 and the length of the display panel 100 in the x-axis direction are larger than the length of the touch sensor substrate 210 in the x-axis direction. In addition, the support 7b is in contact with the protective plate 220 and the display panel 100 at two points to support the protective plate 220 and the display panel 100. This makes it possible to achieve a touch panel that efficiently vibrates with a small force without providing a support that supports both of the front surface 22a and the back surface 22b of the protective plate 220.

<Fifth Modification>

The present modification is applied to the first modification. The configuration of the present modification differs from the configuration of the first modification mainly in the shape of the side surface S2a of the protective plate 220. The configuration other than that of the present modification is similar to the configuration of the first modification.

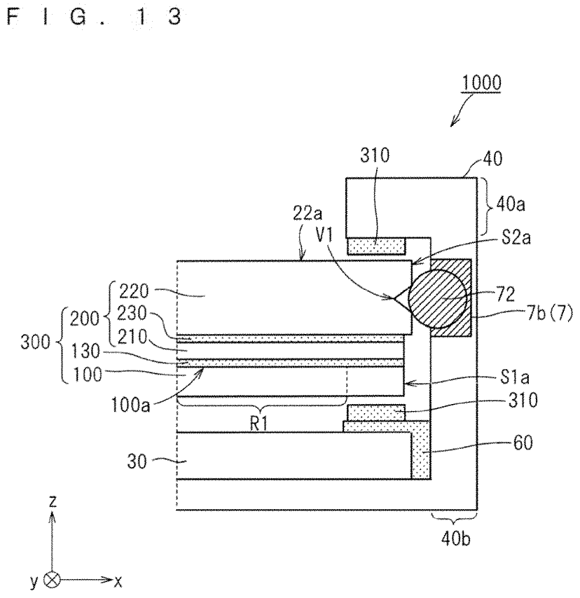

The plan view of the display apparatus 1000 having the configuration of the fifth modification is the same as that in FIG. 8 except that the shape of the side surface S2a of the protective plate 220 is different. FIG. 13 is a cross-sectional view of the display apparatus 1000 having the configuration of the fifth modification taken along line A1a-A2 in FIG. 8.

In the present modification, the shape of the protective plate 220 is different from that of the first modification. Specifically, as shown in FIG. 13, a cutout V1 is provided on the side surface S2a of the protective plate 220.

The cutout V1 is a hole or a groove. The cutout V1 is formed by cutting a part of the side surface S2a. The shape of the cutout V1 is a recessed shape. The length in the y-axis direction of the cutout V1 is sufficiently larger than the length in the z-axis direction of the cutout V1. The cutout V1 extends, for example, from one end of the side surface S2a to the other end of the side surface S2a along the y-axis direction. The surface forming the cutout V1 may be any of a flat surface and a curved surface.

The two respective supports 7b forming a pair in the support pair 7pb support the two side surfaces S2a of the protective plate 220. Each support 7b is in contact with a region in which the cutout V1 is provided in the side surface S2a. Thus, the two supports 7b forming a pair block the motion of the touch panel 200 (protective plate 220) in the x-axis direction. That is, the motion of the movable unit 300 in the x-axis direction is blocked.

In addition, the tip portion of the main ball 72 of the support 7b is accommodated in the cutout V1. The main ball 72 contacts an upper portion of the cutout V1 in the side surface S2a and a lower portion of the cutout V1 in the side surface S2a. Thus, the support 7b also blocks the motion in the z-direction of the touch panel 200 (protective plate 220). That is, the motion of the movable unit 300 in the z direction is also blocked.

That is, the main ball 72 comes into contact with the side surface S2a at two points. Thus, the support 7b blocks the motion in the x-axis direction and the z-direction (z-axis direction) of the touch panel 200 (protective plate 220). That is, the motion in the x-axis direction and the z-direction of the movable unit 300 is blocked. With this structure, the protective plate 220 cannot move upward from the tip of the main ball 72 of the support 7b. In addition, the protective plate 220 cannot move downward from the tip of the main ball 72 of the support 7b.

Therefore, in the configuration of the present modification, it is not necessary to provide the support 7a in contact with the front surface 22a of the protective plate 220 shown in FIG. 2. In addition, in the configuration of the present modification, it is not necessary to provide the support 7a on the back surface side existing below the display panel 100 shown in FIG. 11.

However, in order to prevent the protective plate 220 from jumping out upward, a cushion material 310 is provided between the upper frame 40a of the housing 40 and the front surface 22a of the protective plate 220. The installation method and the installation position of the cushion material 310 are similar to those of the first modification.

In addition, another cushion material 310 is provided also below the display panel 100 similarly to the cushion material 310 of the upper frame 40a. It should be noted that the cushion material 310 is provided at a position outside the display region R1 of the display surface 100a of the display panel 100 and at a position hidden under the upper frame 40a.

As described above, according to the present modification, the cutout V1 is provided on the side surface S2a of the protective plate 220 of the touch panel 200. This makes it possible to achieve a touch panel that efficiently vibrates with a small force without providing a support that supports both of the front surface 22a and the back surface 22b of the protective plate 220.

<Sixth Modification>

The present modification is applied to all or a part of the first embodiment, the first modification, the second modification, the third modification, the fourth modification, and the fifth modification. In the configuration of the present modification, the structure of the support pair (two supports) sandwiching the protective plate 220 in the thickness direction of the protective plate 220 is mainly different.

The configuration of the present modification differs from the configuration of the first embodiment mainly in that a support pair 7pc described below is used instead of the support pair 7pa. The configuration other than that of the present modification is similar to the configuration of the first embodiment. Although details will be described below, the support pair 7pc includes two supports 7c.

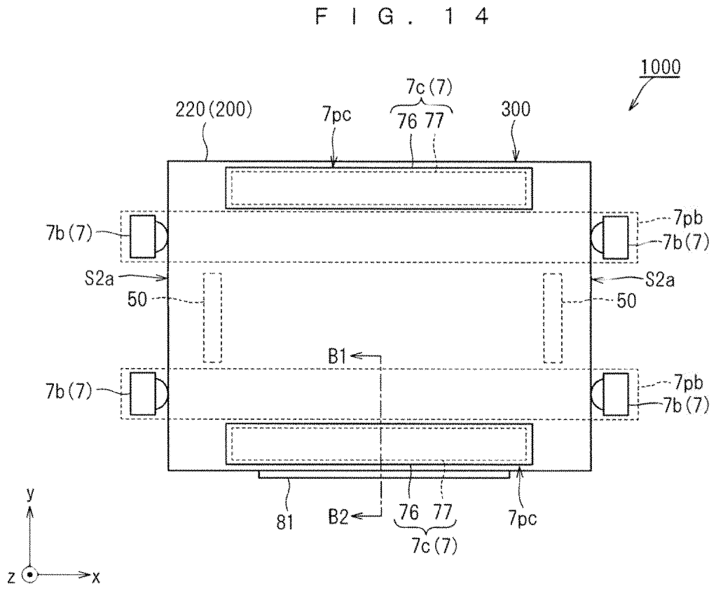

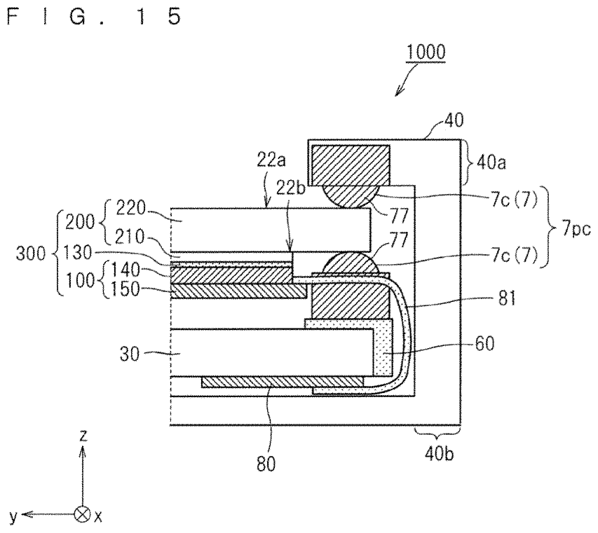

FIG. 14 is a plan view of a display apparatus 1000 having the configuration of the sixth modification. The configuration in FIG. 14 shows, for example, a state in which the configuration of the sixth modification is applied to the configuration in FIG. 1 (first embodiment). FIG. 15 is a cross-sectional view of the display apparatus 1000 having the configuration of the sixth modification taken along line B1-B2 in FIG. 14.

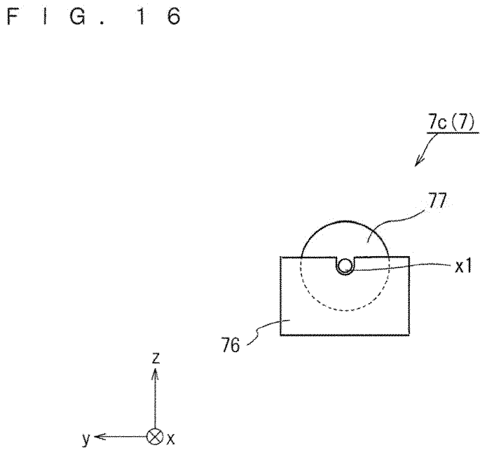

The support 7c is a bearing using a roller. In the present modification, the k supports 7 include a support 7c. FIG. 16 is a cross-sectional view showing the configuration of a support 7c according to the sixth modification.

Referring to FIG. 16, the support 7c includes a cage 76 and a roller 77. The shape of the roller 77 is an elongated shape (columnar shape). The roller 77 extends in an axial direction (for example, x-axis direction). The shape of the yz cross section of the roller 77 is a circle. An elongated (columnar) shaft portion xl is provided on each of the two side surfaces of the roller 77.

The support 7c is configured such that the roller 77 is rotatable. Specifically, the cage 76 houses a part of the roller 77. In addition, the cage 76 supports the shaft portion xl such that the roller 77 is rotatable. The roller 77 rotates with the shaft portion xl as a rotating shaft.

Here, for example, it is assumed that the support 7c is in contact with the back surface 22b of the protective plate 220. In this case, the protective plate 220 is smoothly movable in the lateral direction (for example, y-axis direction) of the roller 77 due to the rotation of the roller 77.

Hereinafter, the support 7c is also referred to as a “support 7”. The display apparatus 1000 includes k supports 7. In the present modification, k is 8, for example.

In the present modification, as shown in FIG. 14, the protective plate 220 of the touch panel 200 is provided with two support pairs 7pc. The two support pairs 7pc are provided along the long sides of the touch panel 200 (protective plate 220). Each of the two support pairs 7pc includes two supports 7c included in the k supports 7 (see FIG. 15).

Each of the two support pairs 7pc sandwiches the protective plate 220 in the thickness direction of the protective plate 220. Specifically, the two supports 7c of each of the two support pairs 7pc sandwich the protective plate 220 in the thickness direction of the protective plate 220.

It should be noted that the two supports 7c sandwich the protective plate 220 by line contact. That is, two supports 7c of each of the two support pairs 7pc are configured so that the touch panel 200 (protective plate 220) does not move in the z-axis direction. That is, two supports 7c of each of the two support pairs 7pc block the motion of the touch panel 200 (protective plate 220) in the z-axis direction. That is, the motion of the movable unit 300 in the z-axis direction is blocked. Hereinafter, the two supports 7c included in the support pair 7pc are also referred to as “two supports 7c forming a pair”.

In addition, as shown in FIG. 15, the two supports 7c forming a pair in the support pair 7pc include a support 7c in contact with the front surface 22a of the protective plate 220. Hereinafter, the support 7c in contact with the front surface 22a of the protective plate 220 is also referred to as a “support 7c on the front surface side”. In addition, the two supports 7c forming a pair include a support 7c in contact with the back surface 22b of the protective plate 220. Hereinafter, the support 7c in contact with the back surface 22b of the protective plate 220 is also referred to as a “support 7c on the back surface side”.

The support 7c on the front surface side is embedded in the upper frame 40a of the housing 40. The support 7c on the front surface side supports the touch panel 200 (protective plate 220) by line contact. Specifically, the support 7c (roller 77) on the front surface side is in line contact with the front surface 22a of the protective plate 220.

The support 7c on the back surface side is disposed on the frame 60. The support 7c (roller 77) on the back surface side is in line contact with the back surface 22b of the protective plate 220. That is, the support 7c (roller 77) on the back surface side supports the touch panel 200 (protective plate 220) by line contact. That is, the support 7c on the back surface side supports the weight of the movable unit 300 including the touch panel 200 and the display panel 100.

In addition, similarly to the first embodiment, the protective plate 220 is provided with two support pairs 7pb. Each of the two support pairs 7pb sandwiches two side surfaces S2a of the protective plate 220. Each of the two support pairs 7pb includes two supports 7b (ball bearings). That is, the support 7b (ball bearing) is provided on the short side of the protective plate 220. Thus, two supports 7b of each of the two support pairs 7pb block the motion of the touch panel 200 (protective plate 220) in the x-axis direction, as in the first embodiment. That is, the motion of the movable unit 300 in the x-axis direction is blocked.

It should be noted that the configuration of the present modification is not limited to the configuration using two support pairs 7pc using the roller 77. One support pair 7pc and one support pair 7pa utilizing the main ball 72 may be used.

In addition, for example, the support in contact with the front surface 22a of the protective plate 220 may be the support 7a, and the support in contact with the back surface 22b of the protective plate 220 may be the support 7c. That is, the protective plate 220 may be sandwiched between the support 7a utilizing the main ball 72 and the support 7c utilizing the roller 77.

In addition, the display apparatus 1000 of the present modification may be installed in an erected state using one of the two side surfaces S2a (short sides) of the protective plate 220 in FIG. 14 as a bottom surface. In this case, the support 7b supports the weight of the protective plate 220. In addition, the motion of the touch panel 200 (protective plate 220) in the x-axis direction and the z-axis direction is blocked by the support pair 7pb (support 7b) and the support pair 7pc (support 7c). Therefore, the touch panel 200 (protective plate 220) can freely move in the y-axis direction being the generation direction of the vibration. That is, the movable unit 300 can freely move in the y-axis direction.

As described above, according to the present modification, the protective plate 220 is supported by line contact using the support 7c utilizing the roller 77. Thus, the touch panel (protective plate) can be supported more stably. In addition, it is possible to achieve a touch panel that efficiently vibrates with a small force.

It should be noted that the number of support pairs 7pc provided on the protective plate 220 is not limited to two, and may be three or more. For example, the size in the x-axis direction of the support pair 7pc in FIG. 14 may be halved, and the two support pairs 7pc whose sizes have been changed may be arranged side by side along the x-axis direction.

<Seventh Modification>

The present modification is applied to the first embodiment. The display apparatus 1000 of the present modification is used in an erected state as in FIG. 7 of the first embodiment. The configuration of the present modification differs from the configuration of the first embodiment mainly in the vibration direction. In the first embodiment, the vibrating element 50 generates vibration in the y-axis direction. In the present modification, the vibrating element 50 generates vibration in the z-axis direction.

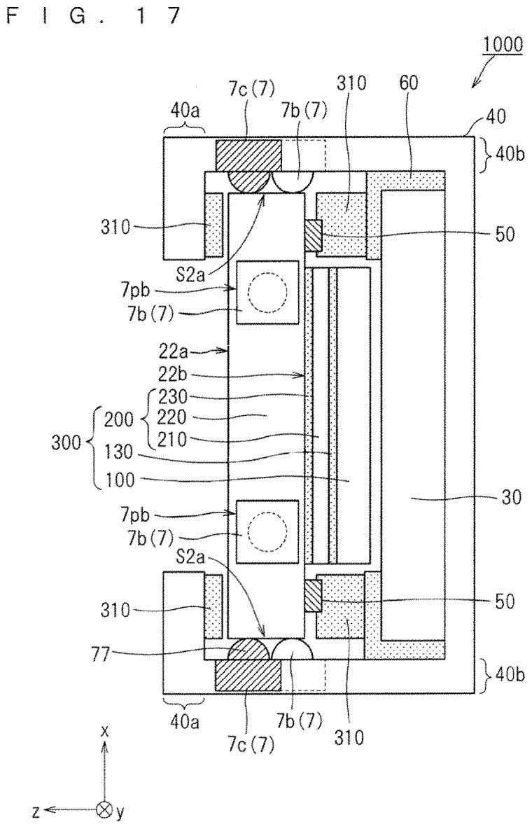

FIG. 17 is a cross-sectional view of a display apparatus 1000 having the configuration of the seventh modification. In the present modification, the weight of the movable unit 300 including the touch panel 200 and the display panel 100 is applied to the side surface S2a of the protective plate 220. A support 7c is embedded in the side surface portion 40b (bottom surface side in FIG. 17) of the housing 40 facing the side surface S2a of the protective plate 220.

As described with reference to FIG. 16, the support 7c is a bearing utilizing the roller 77. The support 7c is arranged so that the axis of the roller 77 extends in the y-axis direction in FIG. 17. The support 7c is in line contact with the side surface S2a of the protective plate 220. Thus, the support 7c supports the weight of the movable unit 300 including the touch panel 200 and the display panel 100. The support 7c is one support 7c of the two supports 7c forming a pair included in the support pair 7pc.

In addition, the support 7c is also embedded in a side surface portion 40b (upper side in FIG. 17) of the housing 40 facing another side surface S2a of the protective plate 220. The support 7c is the other support 7c of the two supports 7c forming a pair included in the support pair 7pc. The other support 7c supports another side surface S2a of the protective plate 220. The motion of the touch panel 200 (protective plate 220) in the x-axis direction is blocked by the two supports 7c forming a pair. That is, the motion of the movable unit 300 in the x-axis direction is blocked.

It should be noted that the rotation of the protective plate 220 with the y axis as the rotation axis cannot be suppressed only by the support of one support pair 7pc. Therefore, as shown in FIG. 17, the support 7b is provided so that the support 7b is in point contact with the side surface S2a of the protective plate 220, for example. At this time, the support 7b is provided at a position deviated from the extension of the axis of the support 7c, and the support 7b needs to support the protective plate 220.

It should be noted that the protective plate 220 has two side surfaces S2b parallel to the xz plane. It should be noted that in FIG. 17, only one of the two side surfaces S2b is shown. In the present modification, two support pairs 7pb are provided on the two side surfaces S2b of the protective plate 220. Each of the two support pairs 7pb sandwiches two side surfaces S2b. Specifically, the two supports 7b forming a pair in each of the two support pairs 7pb sandwich the two side surfaces S2b. The two supports 7b forming a pair sandwich the two side surfaces S2b by point contact.

Thus, the two side surfaces S2b of the protective plate 220 are supported by the two support pairs 7pb. Therefore, the motion of the touch panel 200 (protective plate 220) in the y-axis direction is blocked by the two support pairs 7pb. That is, the motion of the movable unit 300 in the y-axis direction is blocked.

In the present modification, the vibrating element 50 generates vibration in the z-axis direction. As described above, the motion of the touch panel 200 (protective plate 220) in the x-axis direction and the y-axis direction is blocked by the two supports 7c forming a pair, the two supports 7b, and the two support pairs 7pb (supports 7b). Therefore, the touch panel 200 (protective plate 220) can freely move (vibrate) in the generation direction of the vibration and in the z-axis direction in which the motion is not blocked. That is, the movable unit 300 can freely move in the z-axis direction which is the generation direction of the vibration and in which the motion is not blocked.

It should be noted that in order to prevent the protective plate 220 from jumping out in the z direction, a cushion material 310 is provided between the upper frame 40a of the housing 40 and the front surface 22a of the protective plate 220.

The cushion material 310 is bonded to the back surface of the upper frame 40a of the housing 40 with a double-sided tape or an adhesive. In addition, the cushion material 310 is provided also on the frame 60.

In the present modification, when the display apparatus 1000 is used in an erected state, the side surface S2a of the protective plate 220 serving as the bottom surface is supported by the support 7b and the support 7c. Thus, the movable unit 300 including the touch panel 200 and the display panel 100 is stably supported.

It should be noted that the combination of the supports is not limited thereto. For example, a plurality of supports 7 may be used instead of the support 7c.

In addition, the support 7c may be provided instead of the support 7b (support pair 7pb) that blocks the motion of the touch panel 200 (protective plate 220) in the y-axis direction. Also in this configuration, the touch panel 200 (movable unit 300) can smoothly vibrate in the z-axis direction.

As described above, according to the present modification, even when the display apparatus 1000 is used in an erected state, the support 7 supports the side surface S2a of the protective plate 220 by point contact or line contact. That is, the support 7 supports the weight of the movable unit 300 including the touch panel 200 and the display panel 100. Thus, it is possible to achieve a touch panel that efficiently vibrates with a small force.

<Eighth Modification>

The present modification is applied to all or a part of the third modification, the fourth modification, and the fifth modification. The configuration of the present modification is a configuration in which the visually recognizing side of the display apparatus is flat (hereinafter, also referred to as “flat configuration”). Therefore, in the configuration of the present modification, the support 7a on the front surface side that comes into contact with the front surface 22a of the protective plate 220 is not provided.

The configuration of the present modification is applied to, for example, a display in which design is emphasized. The display in which design is emphasized is, for example, an in-vehicle display. Hereinafter, the configuration of the eighth modification is also referred to as a “modified configuration A”. In the modified configuration A, the housing 40 does not have the upper frame 40a.

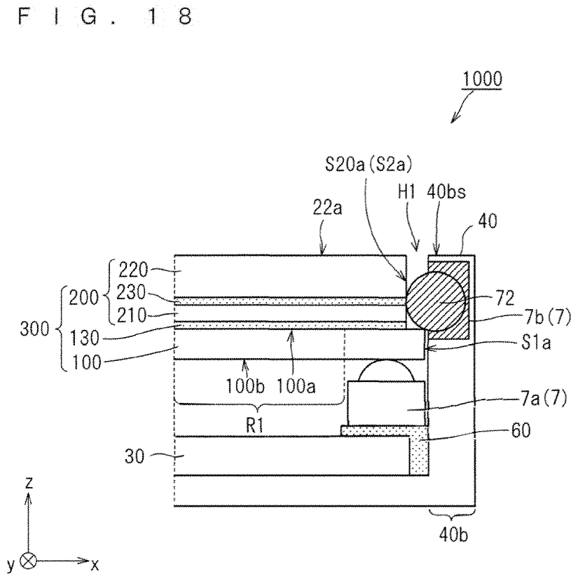

The configuration in which the modified configuration A is applied to the third modification is the configuration in FIG. 18. FIG. 18 is a cross-sectional view of the display apparatus 1000 having the modified configuration A according to the eighth modification. The configuration in FIG. 18 is a configuration obtained by modifying the configuration in FIG. 11 in the third modification. In the modified configuration A, the display apparatus 1000 is installed in a horizontal state. The horizontal state is a state in which the display surface 100a of the display apparatus 1000 is along the horizontal direction.

In the modified configuration A, a gap H1 exists between the side surface of the protective plate 220 and the side surface portion 40b of the housing 40. In FIG. 18, the side surface of the protective plate 220 is, for example, a side surface S2a. In the modified configuration A, the side surface portion 40b has a front surface 40bs. The front surface 40bs is a visually recognizing side surface. In the modified configuration A, the front surface 22a of the protective plate 220 and the front surface 40bs of the side surface portion 40b exist on the same plane.

In addition, the configuration in FIG. 18 also has a feature of the third modification. That is, in the configuration in FIG. 18, the support 7b is provided so that the touch panel 200 and the display panel 100 do not come off from the housing 40 in the direction perpendicular to the display surface 100a.

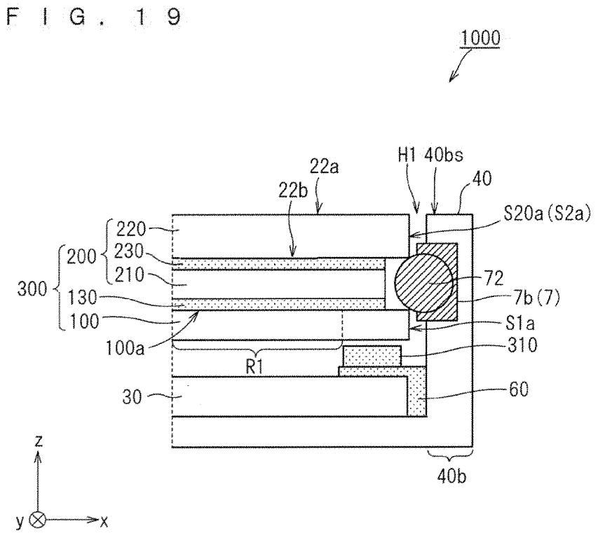

In addition, the configuration in which the modified configuration A is applied to the fourth modification is the configuration in FIG. 19. The configuration in FIG. 19 is a configuration obtained by modifying the configuration in FIG. 12 in the fourth modification. The configuration in FIG. 19 also has a feature of the fourth modification. That is, in the configuration in FIG. 19, the support 7b is provided so that the touch panel 200 and the display panel 100 do not come off from the housing 40 in the direction perpendicular to the display surface 100a. Since the modified configuration A shown in FIG. 19 is similar to the modified configuration A shown in FIG. 18, a detailed description thereof will be omitted.

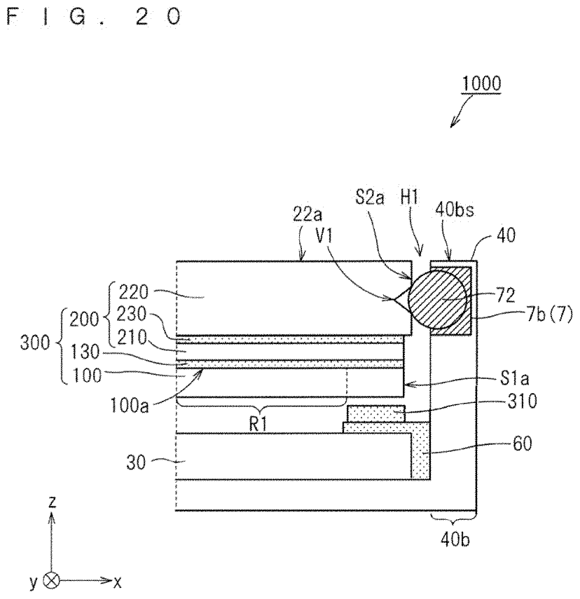

In addition, the configuration in which the modified configuration A is applied to the fifth modification is the configuration in FIG. 20. The configuration in FIG. 20 is a configuration obtained by modifying the configuration in FIG. 13 in the fifth modification. The configuration in FIG. 20 also has a feature of the fifth modification. That is, in the configuration in FIG. 20, the support 7b is provided so that the touch panel 200 and the display panel 100 do not come off from the housing 40 in the direction perpendicular to the display surface 100a.

By the way, in the configurations in FIGS. 18, 19, and 20, dust or the like may enter the inside of the housing 40 through the gap H1. In this case, the following trouble occurs. The trouble is, for example, malfunction of the movable unit 300 due to dust or the like.

Therefore, it is required to suppress the occurrence of the above-described trouble. Hereinafter, a configuration obtained by modifying the modified configuration A is also referred to as a “modified configuration B”. The modified configuration B is also a configuration of the eighth modification. The modified configuration B is configured to suppress the occurrence of the above-described trouble. The modified configuration B is a configuration in which the size of the gap H1 is reduced. The size of the gap H1 is, for example, a size that does not hinder the movement of the movable unit 300 in a situation where the vibrating element 50 generates vibration, and is a size as small as possible. The modified configuration B has an eaves structure.

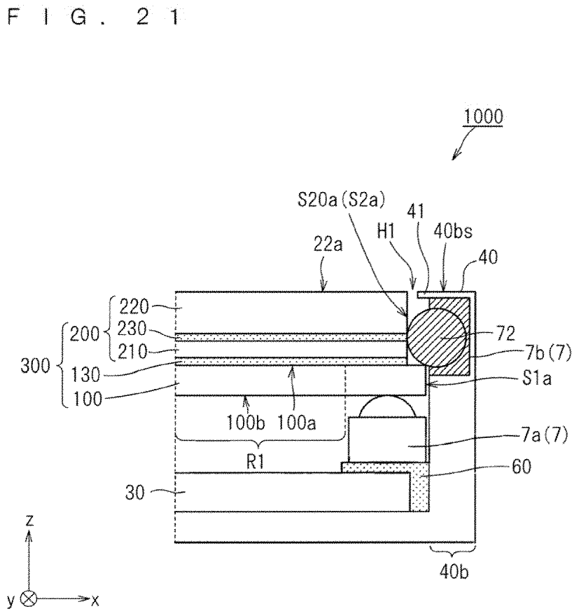

A configuration in which the modified configuration B is applied to the configuration in FIG. 18 having the modified configuration A is the configuration in FIG. 21. Referring to FIG. 21, in the modified configuration B, the side surface portion 40b includes a protrusion 41. The protrusion 41 is provided on the front surface 40bs side of the side surface portion 40b. The protrusion 41 extends toward the inside of the housing 40.

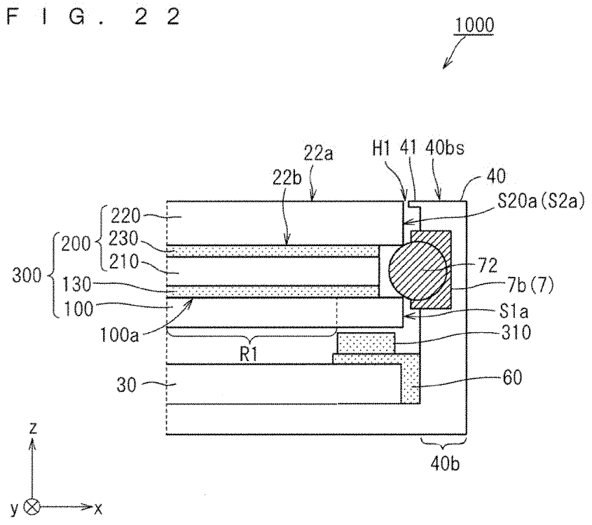

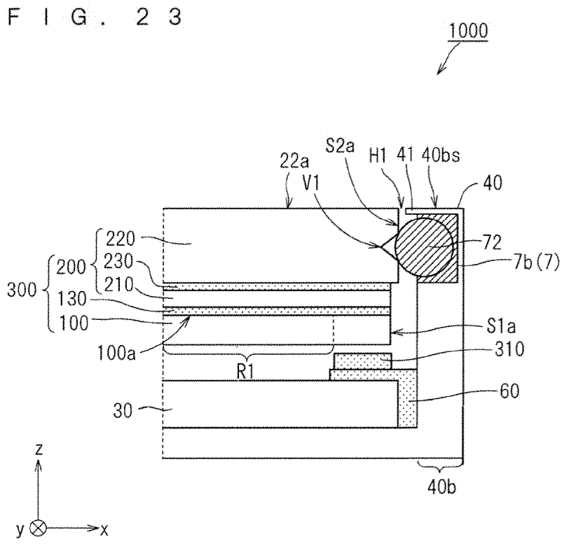

In addition, a configuration in which the modified configuration B is applied to the configuration in FIG. 19 having the modified configuration A is the configuration in FIG. 22. In addition, a configuration in which the modified configuration B is applied to the configuration in FIG. 20 having the modified configuration A is the configuration in FIG. 23.

In addition, a configuration in which the gap H1 existing in the modified configuration A in FIGS. 18, 19, 20, and the like is eliminated (hereinafter, also referred to as a “modified configuration C”) may be used. The modified configuration C is a configuration obtained by modifying the modified configuration A. The modified configuration C is also a configuration of the eighth modification.

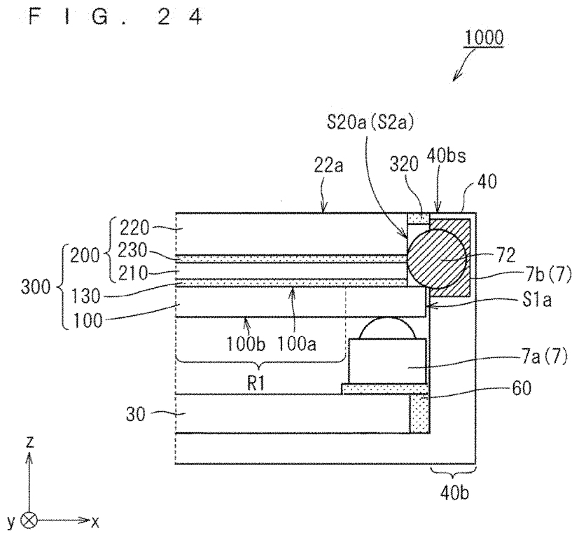

A configuration in which the modified configuration C is applied to the configuration in FIG. 18 having the modified configuration A is the configuration in FIG. 24. Referring to FIG. 24, in the modified configuration C, the display apparatus 1000 includes an elastic member 320. The elastic member 320 has a characteristic of not blocking the motion of the movable unit 300 in the vibration direction. The elastic member 320 has, for example, elasticity. In addition, the elastic member 320 is formed of, for example, a member having a low elastic modulus. In addition, the elastic member 320 has, for example, rebound elasticity and resilience. The elastic member 320 is, for example, a foam material (sponge). In addition, the elastic member 320 may be a sheet-shaped sheet material.

In the modified configuration C, the elastic member 320 is provided between the side surface of the protective plate 220 and the side surface portion 40b of the housing 40. In FIG. 24, the side surface of the protective plate 220 is, for example, a side surface S2a. In addition, in the modified configuration C, the elastic member 320 is sandwiched between the side surface of the protective plate 220 and the side surface portion 40b of the housing 40. That is, the elastic member 320 is in contact with the side surface of the protective plate 220 and the side surface portion 40b.

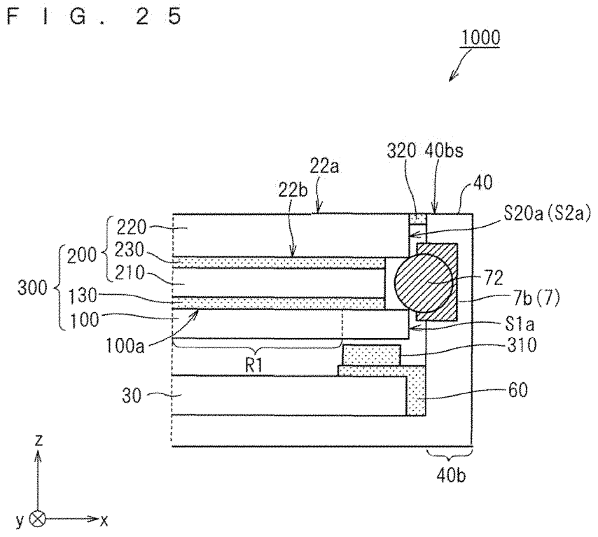

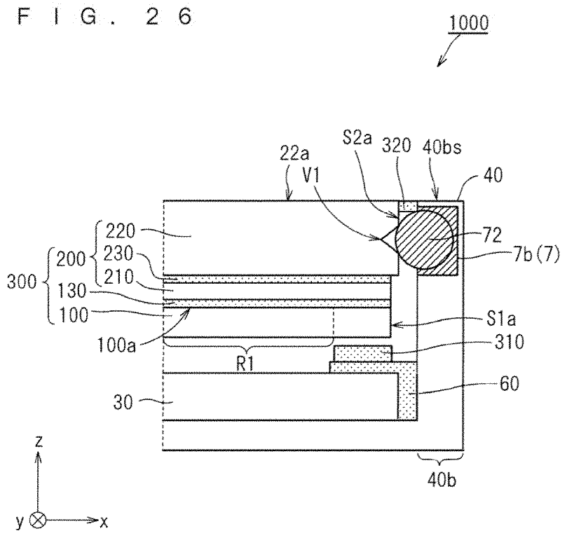

In addition, a configuration in which the modified configuration C is applied to the configuration in FIG. 19 having the modified configuration A is the configuration in FIG. 25. In addition, a configuration in which the modified configuration C is applied to the configuration in FIG. 20 having the modified configuration A is the configuration in FIG. 26.

As described above, according to the present modification, it is possible to achieve the display apparatus in which the visually recognizing side of the display apparatus is flat. In addition, according to the modified configurations B and C of the present modification, it is possible to suppress occurrence of the following trouble. The trouble is, for example, a trouble that dirt or the like enters the inside of the housing 40 through the gap H1. In addition, the trouble is, for example, malfunction of the movable unit 300 due to dust or the like entering the inside of the housing 40.

In the present modification, the situation where the display apparatus 1000 is installed in the horizontal state has been described. It should be noted that the display apparatus 1000 of the present modification may be installed in an oblique state or a vertical state. The oblique state is a state in which the display surface of the display apparatus 1000 is along the oblique direction. The oblique direction is, for example, a direction in which the horizontal direction is inclined. The vertical state is a state in which the display surface of the display apparatus 1000 is along the vertical direction. The vertical state is, for example, a state of the display apparatus 1000 in FIG. 7.

In the display apparatus 1000 in the horizontal state, the load of the display apparatus 1000 is applied to the cage 71 along the vertical direction. On the other hand, in the display apparatus 1000 in the oblique state or the vertical state, the load of the display apparatus 1000 is applied to the cage 71 along the vector direction corresponding to the installation angle of the display apparatus 1000. For example, the vector direction in the oblique state is a direction along the oblique direction. In addition, for example, the vector direction in the vertical state is a direction along the vertical direction.

As shown in FIG. 5, the load applied to the cage 71 is distributed to the plurality of sub balls 73 surrounding the main ball 72 via the main ball 72. In this case, the main ball 72 is held by the cage 71 via the plurality of sub balls 73. Therefore, even when a load along the vector direction is applied to the cage 71, the holding force of the cage 71, the sliding property of the movable unit 300, and the like do not change.

(Other Modifications)

It should be noted that the embodiment and each of the modifications can be freely combined, and the embodiment and each of the modifications can be appropriately modified or omitted.

For example, the flat configuration of the eighth modification does not need to be applied to the entire region on the visually recognizing side of the display apparatus 1000. That is, the flat configuration of the eighth modification may be a configuration applied to a part of the entire region on the visually recognizing side of the display apparatus 1000 (hereinafter, also referred to as a “local flat configuration”).

In the local flat configuration, for example, the configurations in FIGS. 18 to 26 described in the eighth modification are applied to one end portion of the movable unit 300 in the x-axis direction. In this case, in the local flat configuration, the configuration of the other end portion of the movable unit 300 in the x-axis direction may be, for example, the configuration shown in FIGS. 1 and 2. In the local flat configuration, for example, a support 7a on the front surface side in contact with the front surface 22a of the protective plate 220 may be provided.

In addition, in the local flat configuration, for example, the configurations in FIGS. 18 to 26 described in the eighth modification are applied to one end portion of the movable unit 300 in the y-axis direction. In this case, in the local flat configuration, the configuration of the other end portion of the movable unit 300 in the y-axis direction may be, for example, the configuration shown in FIGS. 1 and 2.

In addition, for example, the local flat configuration of the eighth modification may be applied to the display apparatus 1000 in FIGS. 1 and 2 in the first embodiment. In the display apparatus 1000 having this configuration, for example, the FFC 81 (flexible cable) is configured so that the touch panel 200 is configured to move in the vibration direction. In addition, in the display apparatus 1000 having this configuration, for example, the FPC 91 (flexible substrate) is configured so that the touch panel 200 (touch sensor substrate 210) is configured to move in the vibration direction.

In addition, for example, the flat configuration or the local flat configuration of the eighth modification may be applied to the display apparatus 1000 in FIG. 9 in the first modification. The display apparatus 1000 having this configuration has a characteristic configuration of the first modification.

In addition, for example, the flat configuration or the local flat configuration of the eighth modification may be applied to the display apparatus 1000 in FIG. 10 in the second modification. The display apparatus 1000 having this configuration has a characteristic configuration of the second modification.

In addition, for example, in the description and drawings of the first embodiment, the first to sixth modifications, and the eighth modification, the x-axis direction and the y-axis direction may be interchanged with each other. That is, the x-axis direction may be replaced with the y-axis direction, and the y-axis direction may be replaced with the x-axis direction. In the configuration, for example, the vibrating element 50 vibrates the touch panel 200 in the x-axis direction. In addition, in the configuration, the two side surfaces S2a of the protective plate 220 intersect with the y-axis direction. In addition, in the configuration, the touch panel 200 has two side surfaces S20a intersecting with the y-axis direction.

In addition, for example, the configurations of the touch panel 200 and the display panel 100 in FIG. 11 described in the third modification may be applied only to one end portion of the touch panel 200 in the x-axis direction and one end portion of the display panel 100 in the x-axis direction. That is, the configuration of the other end portion of the touch panel 200 in the x-axis direction and the configuration of the other end portion of the display panel 100 in the x-axis direction may be, for example, the configurations shown in FIGS. 1 and 2. That is, at the other end portion of the touch panel 200 in the x-axis direction, the end portion of the protective plate 220 may be sandwiched between two or more support pairs 7pa. It should be noted that in the configuration, the support 7a supports the back surface 22b of the protective plate 220.

In addition, for example, the configurations of the touch panel 200 and the display panel 100 in FIG. 12 described in the fourth modification may be applied only to one end portion of the touch panel 200 in the x-axis direction and one end portion of the display panel 100 in the x-axis direction. That is, the configuration of the other end portion of the touch panel 200 in the x-axis direction and the configuration of the other end portion of the display panel 100 in the x-axis direction may be, for example, the configurations shown in FIGS. 1 and 2. That is, at the other end portion of the touch panel 200 in the x-axis direction, the end portion of the protective plate 220 may be sandwiched between two or more support pairs 7pa. It should be noted that in the configuration, the support 7a supports the back surface 22b of the protective plate 220.

In addition, for example, the configuration of the protective plate 220 in FIG. 13 described in the fifth modification may be applied only to one end portion of the protective plate 220 in the x-axis direction. That is, the configuration of the other end portion of the protective plate 220 in the x-axis direction may be, for example, the configuration shown in FIGS. 1 and 2. That is, the other end portion of the protective plate 220 in the x-axis direction may be sandwiched between two or more support pairs 7pa. It should be noted that in the configuration, the support 7a supports the back surface 22b of the protective plate 220.

In addition, for example, in the display apparatus 1000 of any one of the first, second, third, fourth, fifth, sixth, and eighth modifications, at least three support pairs 7pa sandwiching the protective plate 220 may be provided.

In addition, for example, in the display apparatus 1000 of the first embodiment or the display apparatus 1000 of the modifications other than the third modification, the support 7a that supports the back surface 100b of the display panel 100 shown in FIG. 11 may be further provided.

In addition, for example, in the display apparatus 1000 of the first embodiment or the display apparatus 1000 of the modifications other than the sixth modification, the support pair 7pc of the sixth modification may be further provided. The two supports 7c of the support pair 7pc sandwich the protective plate 220 by line contact.

In addition, for example, in the display apparatus 1000 of the sixth modification or the eighth modification, the support 7a that supports the back surface 22b of the protective plate 220 may be further provided.

In addition, for example, in the display apparatus 1000 of the eighth modification, at least two support pairs 7pb sandwiching the two side surfaces S2a of the protective plate 220 may be provided.

Although the present disclosure is described in detail, the above description is in all aspects exemplification, and the present disclosure is not limited to the above description. It is understood that innumerable modifications not exemplified can be envisaged.

### EXPLANATION OF REFERENCE SIGNS

7, 7a, 7b, 7c: support
7pa, 7pb, 7pc: support pair
30: backlight
40: housing
50: vibrating element
80: control board
81: FFC
90: touch detection circuit
91: FPC
100: display panel
100a: display surface
200: touch panel
210: touch sensor substrate
220: protective plate
300: movable unit
1000, J1: display apparatus
H1: gap
S1a, S2a, S2b, S20a: side surface
V1: cutout

1.-18. (canceled)

19. A display apparatus comprising:
a display panel having a display surface being a surface for displaying an image;
a touch panel bonded to the display surface of the display panel;
a vibrating element configured to generate vibration in the touch panel; and
a housing configured to accommodate the touch panel,
wherein in the display apparatus, there exist three directions including a first direction and a second direction along the display surface and a third direction orthogonal to the display surface, and
the first direction and the second direction are orthogonal to each other,
the display apparatus further comprising a plurality of supports configured so that the touch panel does not move in two directions included in the three directions,
wherein the plurality of supports include a support that supports the touch panel by point contact or line contact,
a direction other than the two directions among the three directions coincides with a vibration direction being a direction of vibration generated by the vibrating element, and
the touch panel is configured so that the touch panel is configured to move in the vibration direction.

20. The display apparatus according to claim 19, wherein the touch panel includes a touch sensor substrate and a protective plate.

21. The display apparatus according to claim 19, wherein
the touch panel includes a protective plate,
the protective plate includes two side surfaces intersecting with the first direction or the second direction,
the protective plate is provided with at least three first support pairs sandwiching the protective plate in a thickness direction of the protective plate,
each of the at least three first support pairs includes two first supports included in the plurality of supports,
the two first supports of each of the at least three first support pairs sandwich the protective plate in a thickness direction of the protective plate,
the protective plate is provided with at least two second support pairs sandwiching the two side surfaces of the protective plate,
each of the at least two second support pairs includes two second supports included in the plurality of supports, and
the two second supports of each of the at least two second support pairs sandwich the two side surfaces.

22. The display apparatus according to claim 19, wherein each of the plurality of supports is a bearing having a function of receiving a load generated by motion of the touch panel.

23. The display apparatus according to claim 19, wherein
the touch panel includes a protective plate,
the protective plate includes a back surface being a surface covering the display surface of the display panel, and
the plurality of supports include a support that supports the back surface of the protective plate.

24. The display apparatus according to claim 19, wherein the plurality of supports include a support that supports a surface opposite to the display surface in the display panel.

25. The display apparatus according to claim 19, wherein
the touch panel includes a protective plate, and
the plurality of supports include a second support being a support that supports a side surface of the protective plate.

26. The display apparatus according to claim 25, wherein
the side surface of the protective plate is an inclined surface,
the protective plate includes:
a front surface being a visually recognizing side surface; and
a back surface being a surface covering the display surface of the display panel,
a contour of the side surface of the protective plate includes four sides, and
a side corresponding to an end of the back surface among the four sides is closer to the second support than a side corresponding to an end of the front surface among the four sides.

27. The display apparatus according to claim 25, wherein
the protective plate includes a front surface being a visually recognizing side surface,
a shape of the side surface of the protective plate is convex, and
in a convex side surface being the side surface of the protective plate, the second support comes into contact with a region closer to the front surface than an apex of the convex side surface.

28. The display apparatus according to claim 25, wherein
a cutout is provided on the side surface of the protective plate, and
in the side surface of the protective plate, the second support is in contact with a region in which the cutout is provided.

29. The display apparatus according to claim 19, wherein
the touch panel includes two side surfaces intersecting with the first direction or the second direction,
the plurality of supports include a support in contact with the touch panel and the display panel, and
a size of the touch panel in an intersecting direction being a direction intersecting the two side surfaces of the touch panel is smaller than a size of the display panel in the intersecting direction.

30. The display apparatus according to claim 19, wherein
the touch panel includes a touch sensor substrate and a protective plate,
the touch panel includes two side surfaces intersecting with the first direction or the second direction,
the plurality of supports include a support in contact with the protective plate and the display panel,
a size of the protective plate in an intersecting direction being a direction intersecting the two side surfaces of the touch panel is larger than a size of the touch sensor substrate in the intersecting direction, and
a size of the display panel in the intersecting direction is larger than a size of the touch sensor substrate in the intersecting direction.

31. The display apparatus according to claim 19, wherein
the display apparatus further comprises a backlight disposed at a position away from the display panel, and
the housing accommodates the backlight.

32. The display apparatus according to claim 31, wherein
a control board configured to control the display panel is provided on a back surface of the backlight,
the control board and the display panel are connected to each other with a flexible cable, and
the flexible cable is configured so that the touch panel is configured to move in the vibration direction.

33. The display apparatus according to claim 31, wherein
a touch detection circuit configured to detect a touched position on the touch panel is provided on a back surface of the backlight,
the touch detection circuit and the touch panel are connected to each other with a flexible substrate, and
the flexible substrate is configured so that the touch panel is configured to move in the vibration direction.

34. The display apparatus according to claim 19, wherein
the touch panel includes a protective plate,
the protective plate includes a front surface being a visually recognizing side surface,
the housing includes a side surface portion facing a side surface of the protective plate,
the side surface portion includes another front surface being a visually recognizing side surface, and
the front surface of the protective plate and the other front surface of the side surface portion exist on a same plane.

35. The display apparatus according to claim 34, wherein
an elastic member having elasticity is provided between a side surface of the protective plate and the side surface portion of the housing, and
the elastic member is in contact with the side surface of the protective plate and the side surface portion.
